(19) United States
(12) Patent Application Publication
(10) Pub. No.: US 2020/0142432 A1
(43) Pub. Date: May 7, 2020

(54) METHOD OF LANDING UNMANNED AERIAL ROBOT USING POSTURE CONTROL THEREOF IN UNMANNED AERIAL SYSTEM AND APPARATUS FOR SUPPORTING THE SAME

(71) Applicant: LG ELECTRONICS INC., Seoul (KR)

(72) Inventors: Pilwon KWAK, Seoul (KR); Daeun KIM, Seoul (KR); Sanghak LEE, Seoul (KR); Jeongkyo SEO, Seoul (KR); Beomseok CHAE, Seoul (KR)

(73) Assignee: LG ELECTRONICS INC., Seoul (KR)

(21) Appl. No.: 16/552,888

(22) Filed: Aug. 27, 2019

(30) Foreign Application Priority Data
Aug. 16, 2019 (KR) 10-2019-0100560

(51) Int. Cl. G05D 1/10; B64C 39/02; B64D 47/08; B60L 53/52

(52) U.S. Cl. CPC G05D 1/102; B64C 39/024; B64D 47/08; B60L 53/52; B64C 2201/066; B64C 2201/108; B64C 2201/042; B64C 2201/127; B64C 2201/027

(57) ABSTRACT

Provided is an operation/posture control method of an unmanned aerial robot. More particularly, a position and posture of the unmanned aerial robot may be measured using a first sensor, and sensing information of the wind for charging a battery of the unmanned aerial robot may be measured using a second sensor. A drone based on the sensing information controls a posture of the unmanned aerial robot such that an angle between the unmanned aerial robot and the ground becomes a specific angle to generate power through a rotation of a propeller in the specific angle based on the sensing information, and the battery may be charged through the generated power.

### CROSS-REFERENCE TO RELATED APPLICATIONS

This application claims the benefit of Korea Patent Application No. 10-2019-0100560, filed on Aug. 16, 2019, the contents of which are all hereby incorporated by reference herein in their entirety.

### BACKGROUND OF THE INVENTION

### Field of the Invention

The present invention relates to an unmanned aerial system, and more particularly, to a method of landing an unmanned aerial robot at a position perpendicular to the ground by controlling a posture of the unmanned aerial robot and an apparatus for supporting the same.

### Related Art

An unmanned aerial vehicle generally refers to an aircraft and a helicopter-shaped unmanned aerial vehicle/uninhabited aerial vehicle (UAV) capable of a flight and pilot by the induction of a radio wave without a pilot. A recent unmanned aerial vehicle is increasingly used in various civilian and commercial fields, such as image photographing, unmanned delivery service, and disaster observation, in addition to military use such as reconnaissance and an attack.

Meanwhile, unmanned aerial vehicles for civilian and commercial use should be restrictively operated because construction of foundation such as various regulations, authentication and a legal system is insufficient, and it is difficult for users of unmanned aerial vehicles to recognize potential dangers or dangers that can be posed to public. Particularly, occurrence of collision accidents, flight over security areas, invasion of privacy and the like tends to increase due to indiscreet use of unmanned aerial vehicles.

Many countries are trying to improve new regulations, standards, policies and procedures with respect to operation of unmanned aerial vehicles.

### SUMMARY OF THE INVENTION

The present specification provides a method of transmitting and receiving information monitored by an unmanned aerial robot at a particular position using a 5G system.

The present specification provides a method of controlling and landing an posture of an unmanned aerial robot using a 5G system.

The present specification further provides a method of landing an unmanned aerial robot at a position perpendicular to the ground by controlling a posture of the unmanned aerial robot and a rotation of a propeller.

The present specification further provides a method of landing an unmanned aerial robot at a position perpendicular to the ground by controlling a forward rotation and a reverse rotation of a propeller such that a pitch posture angle of the unmanned aerial robot is a vertical angle.

The present specification further provides a method of charging a battery of an unmanned aerial robot using a wind blowing perpendicularly to the propeller by landing the unmanned aerial robot at a position perpendicular to the ground.

The present specification further provides a method in which an unmanned aerial robot monitors a predetermined area using a camera without hovering by landing the unmanned aerial robot at a position perpendicular to the ground.

The technical problems of the present invention are not limited to the above-described technical problems and the other technical problems will be understood by those skilled in the art from the following description.

In an aspect, a method of landing a rotary wing unmanned aerial robot includes recognizing a position for landing and perpendicular to the ground using a sensor; moving to the recognized position; controlling, when a distance between the position and the rotary wing unmanned aerial robot is within a predetermined distance, a posture of the rotary wing unmanned aerial robot and a pitch posture angle to the ground through a forward rotation and a reverse rotation of the propeller; and landing at the position through the control of the posture and the pitch posture angle.

The moving of to the recognized position may be performed through a forward rotation of the propeller and include increasing a speed of a horizontal axis moving to the position.

The controlling of a posture of the rotary wing unmanned aerial robot may include increasing a vertical axis speed through the forward rotation; and increasing the pitch posture angle through increase of the vertical axis speed.

The controlling of a posture of the rotary wing unmanned aerial robot may further include contacting the position using the forward rotation and the reverse rotation of the propeller, when the pitch posture angle is perpendicular to the ground, and the pitch posture angle may be maintained through a forward rotation and/or a reverse rotation of each of the propellers.

When the pitch posture angle increases greater than a vertical angle, an upper propeller of the propellers may perform a reverse rotation and a lower propeller may perform a forward rotation to vertically maintain the pitch posture angle.

When the pitch posture angle reduces smaller than a vertical angle, an upper propeller and a lower propeller of the propellers may perform a forward rotation, and a rotation speed of the upper propeller may be smaller than that of the lower propeller.

While the pitch posture angle maintains a vertical state, an upper propeller and a lower propeller of the propellers may be moved to the position in the vertical state through a reverse rotation.

When the rotor unmanned aerial robot approaches to the position, an upper propeller and a lower propeller of the propellers may perform a reverse rotation, and a reverse rotation speed of the upper propeller may be greater than that of the lower propeller.

The controlling of a posture of the rotary wing unmanned aerial robot may be performed in a state in which a vertical axis speed of the rotary wing unmanned aerial robot is 0.

The method may further include generating, after the landing, power using a rotation of the propeller by the wind; and charging a battery using the generated power.

The method may further include monitoring, after the landing, a region within a predetermined range using a camera.

In another aspect, a rotary wing unmanned aerial robot includes a wireless communication unit; a main body; at least one motor; at least one sensor; a propeller connected to each of the at least one motor; and a processor electrically connected to the at least one motor to control the at least one motor, wherein the processor controls the at least one sensor to recognize a position for landing and perpendicular to the ground, controls the at least one motor and the propeller to move to the recognized position, controls the propeller and the at least one sensor to control a posture and a pitch posture angle to the ground of the rotary wing unmanned aerial robot through a forward rotation and a reverse rotation of the propeller when a distance between the position and the rotary wing unmanned aerial robot is within a predetermined distance, and controls the propeller and the at least one sensor to land at the position through the control of the posture and the pitch posture angle.

### BRIEF DESCRIPTION OF THE DRAWINGS

The accompanying drawings, included as part of the detailed description in order to help understanding of the present invention, provide embodiments of the present invention and describe the technical characteristics of the present invention along with the detailed description.

FIG. 1 shows a perspective view of an unmanned aerial vehicle to which a method proposed in this specification is applicable.

FIG. 2 is a block diagram showing a control relation between major elements of the unmanned aerial vehicle of FIG. 1.

FIG. 3 is a block diagram showing a control relation between major elements of an aerial control system according to an embodiment of the present invention.

FIG. 4 illustrates a block diagram of a wireless communication system to which methods proposed in this specification are applicable.

FIG. 5 is a diagram showing an example of a signal transmission/reception method in a wireless communication system.

FIG. 6 shows an example of a basic operation of a robot and a 5G network in a 5G communication system.

FIG. 7 illustrates an example of a basic operation between robots using 5G communication.

FIG. 8 is a diagram showing an example of the concept diagram of a 3GPP system including a UAS.

FIG. 9 shows examples of a C2 communication model for a UAV.

FIG. 10 is a flowchart showing an example of a measurement execution method to which the present invention is applicable.

FIG. 11 is a diagram illustrating an example of a structure in which a drone lands at a position perpendicular to the ground according to an embodiment of the present invention.

FIG. 12 is a diagram illustrating an example of a monitoring method of a drone according to an embodiment of the present invention.

FIG. 13 is a flowchart illustrating an example of a method in which a drone lands at a position perpendicular to the ground and performs a specific operation according to an embodiment of the present invention.

FIG. 14 is a diagram illustrating an example of a control method according to an embodiment of the present invention.

FIG. 15 is a diagram illustrating an example of another control method according to an embodiment of the present invention.

FIG. 16 is a diagram illustrating an example of a method in which a drone recognizes an outer wall according to an embodiment of the present invention.

FIG. 17 is a flowchart illustrating an example of a method in which a drone lands at a position perpendicular to the ground according to an embodiment of the present invention.

FIG. 18 is a diagram illustrating another example of a method in which a drone lands at a position perpendicular to the ground according to an embodiment of the present invention.

FIG. 19 is a flowchart illustrating an example of a method of landing a drone by controlling a posture of the drone and a rotation of a propeller according to an embodiment of the present invention.

FIG. 20 is a block diagram illustrating a wireless communication device according to an embodiment of the present invention.

FIG. 21 is a block diagram illustrating a communication device according to an embodiment of the present invention.

### DESCRIPTION OF EXEMPLARY EMBODIMENTS

It is noted that technical terms used in this specification are used to explain a specific embodiment and are not intended to limit the present invention. In addition, technical terms used in this specification agree with the meanings as understood by a person skilled in the art unless defined to the contrary and should be interpreted in the context of the related technical writings not too ideally or impractically.

Furthermore, if a technical term used in this specification is an incorrect technical term that cannot correctly represent the spirit of the present invention, this should be replaced by a technical term that can be correctly understood by those skill in the air to be understood. Further, common terms as found in dictionaries should be interpreted in the context of the related technical writings not too ideally or impractically unless this disclosure expressly defines them so.

Further, an expression of the singular number may include an expression of the plural number unless clearly defined otherwise in the context. The term “comprises” or “includes” described herein should be interpreted not to exclude other elements or steps but to further include such other elements or steps since the corresponding elements or steps may be included unless mentioned otherwise.

In addition, it is to be noted that the suffixes of elements used in the following description, such as a “module” and a “unit”, are assigned or interchangeable with each other by taking into consideration only the ease of writing this specification, but in themselves are not particularly given distinct meanings and roles.

Further, terms including ordinal numbers, such as the first and the second, may be used to describe various elements, but the elements are not restricted by the terms. The terms are used to only distinguish one element from the other element. For example, a first component may be called a second component and the second component may also be called the first component without departing from the scope of the present invention.

Hereinafter, preferred embodiments according to the present invention are described in detail with reference to the accompanying drawings. The same reference numerals are assigned to the same or similar elements regardless of their reference numerals, and redundant descriptions thereof are omitted.

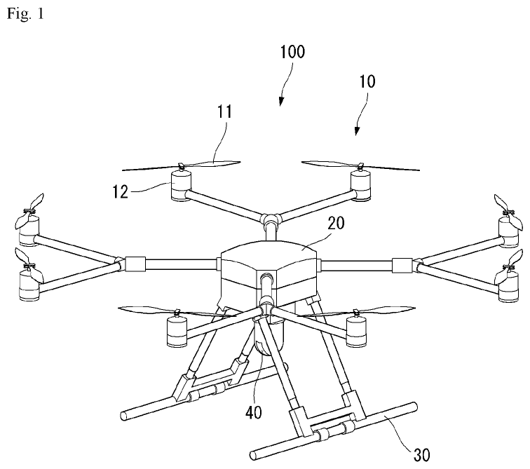

FIG. 1 shows a perspective view of an unmanned aerial vehicle according to an embodiment of the present invention.

First, the unmanned aerial vehicle 100 is manually manipulated by an administrator on the ground, or it flies in an unmanned manner while it is automatically piloted by a configured flight program. The unmanned aerial vehicle 100, as in FIG. 1, includes a main body 20, a horizontal and vertical movement propulsion device 10, and landing legs 130.

The main body 20 is a body portion on which a module, such as a task unit 40, is mounted.

The horizontal and vertical movement propulsion device 10 includes one or more propellers 11 positioned vertically to the main body 20. The horizontal and vertical movement propulsion device 10 according to an embodiment of the present invention includes a plurality of propellers 11 and motors 12, which are spaced apart. In this case, the horizontal and vertical movement propulsion device 10 may have an air jet propeller structure not the propeller 11.

A plurality of propeller supports is radially formed in the main body 20. The motor 12 may be mounted on each of the propeller supports. The propeller 11 is mounted on each motor 12.

The plurality of propellers 11 may be disposed symmetrically with respect to the main body 20. Furthermore, the rotation direction of the motor 12 may be determined so that the clockwise and counterclockwise rotation directions of the plurality of propellers 11 are combined. The rotation direction of one pair of the propellers 11 symmetrical with respect to the main body 20 may be set identically (e.g., clockwise). Furthermore, the other pair of the propellers 11 may have a rotation direction opposite (e.g., counterclockwise) that of the one pair of the propellers 11.

The landing legs 30 are disposed with being spaced apart at the bottom of the main body 20. Furthermore, a buffering support member (not shown) for minimizing an impact attributable to a collision with the ground when the unmanned aerial vehicle 100 makes a landing may be mounted on the bottom of the landing leg 30. The unmanned aerial vehicle 100 may have various aerial vehicle structures different from that described above.

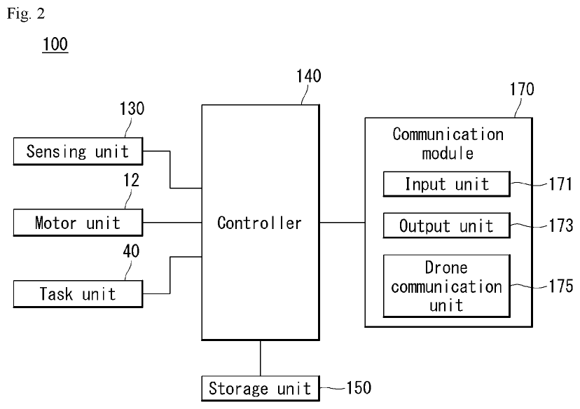

FIG. 2 is a block diagram showing a control relation between major elements of the unmanned aerial vehicle of FIG. 1.

Referring to FIG. 2, the unmanned aerial vehicle 100 measures its own flight state using a variety of types of sensors in order to fly stably. The unmanned aerial vehicle 100 may include a sensing unit 130 including at least one sensor.

The flight state of the unmanned aerial vehicle 100 is defined as rotational states and translational states.

The rotational states mean “yaw”, “pitch”, and “roll.” The translational states mean longitude, latitude, altitude, and velocity.

In this case. “roll”. “pitch”, and “yaw” are called Euler angle, and indicate that the x, y, z three axes of an aircraft body frame coordinate have been rotated with respect to a given specific coordinate, for example, three axes of NED coordinates N. E. D. If the front of an aircraft is rotated left and right on the basis of the z axis of a body frame coordinate, the x axis of the body frame coordinate has an angle difference with the N axis of the NED coordinate, and this angle is called “yaw” (Ψ). If the front of an aircraft is rotated up and down on the basis of the y axis toward the right, the z axis of the body frame coordinate has an angle difference with the D axis of the NED coordinates, and this angle is called a “pitch” (θ). If the body frame of an aircraft is inclined left and right on the basis of the x axis toward the front, the y axis of the body frame coordinate has an angle to the E axis of the NED coordinates, and this angle is called “roll” (Φ).

The unmanned aerial vehicle 100 uses 3-axis gyroscopes, 3-axis accelerometers, and 3-axis magnetometers in order to measure the rotational states, and uses a GPS sensor and a barometric pressure sensor in order to measure the translational states.

The sensing unit 130 of the present invention includes at least one of the gyroscopes, the accelerometers, the GPS sensor, the image sensor or the barometric pressure sensor. In this case, the gyroscopes and the accelerometers measure the states in which the body frame coordinates of the unmanned aerial vehicle 100 have been rotated and accelerated with respect to earth centered inertial coordinate. The gyroscopes and the accelerometers may be fabricated as a single chip called an inertial measurement unit (IMU) using a micro-electro-mechanical systems (MEMS) semiconductor process technology.

Furthermore, the IMU chip may include a microcontroller for converting measurement values based on the earth centered inertial coordinates, measured by the gyroscopes and the accelerometers, into local coordinates, for example, north-east-down (NED) coordinates used by GPSs.

The gyroscopes measure angular velocity at which the body frame coordinate x, y, z three axes of the unmanned aerial vehicle 100 rotate with respect to the earth centered inertial coordinates, calculate values (Wx.gyro, Wy.gyro, Wz.gyro) converted into fixed coordinates, and convert the values into Euler angles (Φgyro, θgyro, ψgyro) using a linear differential equation.

The accelerometers measure acceleration for the earth centered inertial coordinates of the body frame coordinate x, y, z three axes of the unmanned aerial vehicle 100, calculate values (fx,acc, fy,acc, fz,acc) converted into fixed coordinates, and convert the values into “roll (Φacc)” and “pitch (θacc).” The values are used to remove a bias error included in “roll (Φgyro)” and “pitch (θgyro)” using measurement values of the gyroscopes.

The magnetometers measure the direction of magnetic north points of the body frame coordinate x, y, z three axes of the unmanned aerial vehicle 100, and calculate a “yaw” value for the NED coordinates of body frame coordinates using the value.

The GPS sensor calculates the translational states of the unmanned aerial vehicle 100 on the NED coordinates, that is, a latitude (Pn.GPS), a longitude (Pe.GPS), an altitude (hMSL.GPS), velocity (Vn.GPS) on the latitude, velocity (Ve.GPS) on longitude, and velocity (Vd.GPS) on the altitude, using signals received from GPS satellites. In this case, the subscript MSL means a mean sea level (MSL).

The barometric pressure sensor may measure the altitude (hALP.baro) of the unmanned aerial vehicle 100. In this case, the subscript ALP means an air-level pressor. The barometric pressure sensor calculates a current altitude from a take-off point by comparing an air-level pressor when the unmanned aerial vehicle 100 takes off with an air-level pressor at a current flight altitude.

The camera sensor may include an image sensor (e.g., CMOS image sensor), including at least one optical lens and multiple photodiodes (e.g., pixels) on which an image is focused by light passing through the optical lens, and a digital signal processor (DSP) configuring an image based on signals output by the photodiodes. The DSP may generate a moving image including frames configured with a still image, in addition to a still image.

The unmanned aerial vehicle 100 includes a communication module 170 for inputting or receiving information or outputting or transmitting information. The communication module 170 may include a drone communication unit 175 for transmitting/receiving information to/from a different external device. The communication module 170 may include an input unit 171 for inputting information. The communication module 170 may include an output unit 173 for outputting information.

The output unit 173 may be omitted from the unmanned aerial vehicle 100, and may be formed in a terminal 300.

For example, the unmanned aerial vehicle 100 may directly receive information from the input unit 171. For another example, the unmanned aerial vehicle 100 may receive information, input to a separate terminal 300 or server 200, through the drone communication unit 175.

For example, the unmanned aerial vehicle 100 may directly output information to the output unit 173. For another example, the unmanned aerial vehicle 100 may transmit information to a separate terminal 300 through the drone communication unit 175 so that the terminal 300 outputs the information.

The drone communication unit 175 may be provided to communicate with an external server 200, an external terminal 300, etc. The drone communication unit 175 may receive information input from the terminal 300, such as a smartphone or a computer. The drone communication unit 175 may transmit information to be transmitted to the terminal 300. The terminal 300 may output information received from the drone communication unit 175.

The drone communication unit 175 may receive various command signals from the terminal 300 or/and the server 200. The drone communication unit 175 may receive area information for driving, a driving route, or a driving command from the terminal 300 or/and the server 200. In this case, the area information may include flight restriction area (A) information and approach restriction distance information.

The input unit 171 may receive On/Off or various commands. The input unit 171 may receive area information. The input unit 171 may receive object information. The input unit 171 may include various buttons or a touch pad or a microphone.

The output unit 173 may notify a user of various pieces of information. The output unit 173 may include a speaker and/or a display. The output unit 173 may output information on a discovery detected while driving. The output unit 173 may output identification information of a discovery. The output unit 173 may output location information of a discovery.

The unmanned aerial vehicle 100 includes a controller 140 for processing and determining various pieces of information, such as mapping and/or a current location. The controller 140 may control an overall operation of the unmanned aerial vehicle 100 through control of various elements that configure the unmanned aerial vehicle 100.

The controller 140 may receive information from the communication module 170 and process the information. The controller 140 may receive information from the input unit 171, and may process the information. The controller 140 may receive information from the drone communication unit 175, and may process the information.

The controller 140 may receive sensing information from the sensing unit 130, and may process the sensing information.

The controller 140 may control the driving of the motor 12. The controller 140 may control the operation of the task unit 40.

The unmanned aerial vehicle 100 includes a storage unit 150 for storing various data. The storage unit 150 records various pieces of information necessary for control of the unmanned aerial vehicle 100, and may include a volatile or non-volatile recording medium.

A map for a driving area may be stored in the storage unit 150. The map may have been input by the external terminal 300 capable of exchanging information with the unmanned aerial vehicle 100 through the drone communication unit 175, or may have been autonomously learnt and generated by the unmanned aerial vehicle 100. In the former case, the external terminal 300 may include a remote controller, a PDA, a laptop, a smartphone or a tablet on which an application for a map configuration has been mounted, for example.

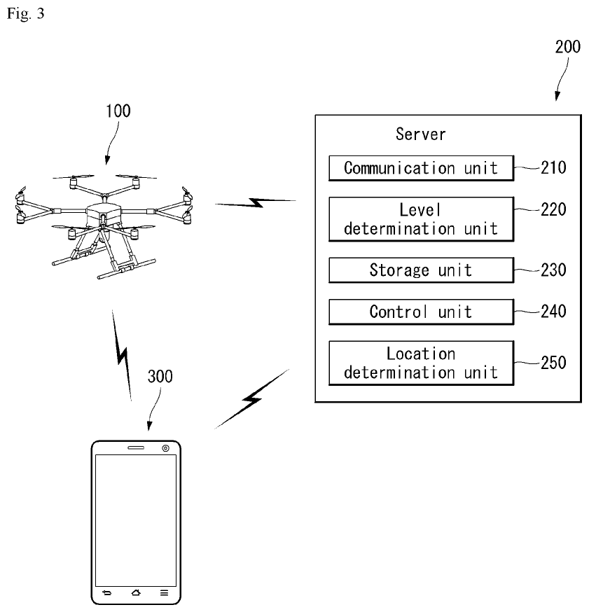

FIG. 3 is a block diagram showing a control relation between major elements of an aerial control system according to an embodiment of the present invention.

Referring to FIG. 3, the aerial control system according to an embodiment of the present invention may include the unmanned aerial vehicle 100 and the server 200, or may include the unmanned aerial vehicle 100, the terminal 300, and the server 200. The unmanned aerial vehicle 100, the terminal 300, and the server 200 are interconnected using a wireless communication method.

Global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), etc. may be used as the wireless communication method.

A wireless Internet technology may be used as the wireless communication method. The wireless Internet technology includes a wireless LAN (WLAN), wireless-fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and 5G, for example. In particular, a faster response is possible by transmitting/receiving data using a 5G communication network.

In this specification, a base station has a meaning as a terminal node of a network that directly performs communication with a terminal. In this specification, a specific operation illustrated as being performed by a base station may be performed by an upper node of the base station in some cases. That is, it is evident that in a network configured with a plurality of network nodes including a base station, various operations performed for communication with a terminal may be performed by the base station or different network nodes other than the base station. A “base station (BS)” may be substituted with a term, such as a fixed station, a Node B, an evolved-NodeB (eNB), a base transceiver system (BTS), an access point (AP), or a next generation NodeB (gNB). Furthermore, a “terminal” may be fixed or may have mobility, and may be substituted with a term, such as a user equipment (UE), a mobile station (MS), a user terminal (UT), a mobile subscriber station (MSS), a subscriber station (SS), an advanced mobile station (AMS), a wireless terminal (WT), a machine-type communication (MTC) device, a machine-to-machine (M2M) device, or a device-to-device (D2D) device.

Hereinafter, downlink (DL) means communication from a base station to a terminal. Uplink (UL) means communication from a terminal to a base station. In the downlink, a transmitter may be part of a base station, and a receiver may be part of a terminal. In the uplink, a transmitter may be part of a terminal, and a receiver may be part of a base station.

Specific terms used in the following description have been provided to help understanding of the present invention. The use of such a specific term may be changed into another form without departing from the technical spirit of the present invention.

Embodiments of the present invention may be supported by standard documents disclosed in at least one of IEEE 802, 3GPP and 3GPP2, that is, radio access systems. That is, steps or portions not described in order not to clearly disclose the technical spirit of the present invention in the embodiments of the present invention may be supported by the documents. Furthermore, all terms disclosed in this document may be described by the standard documents.

In order to clarity the description, 3GPP 5G is chiefly described, but the technical characteristic of the present invention is not limited thereto.

UE and 5G Network Block Diagram Example

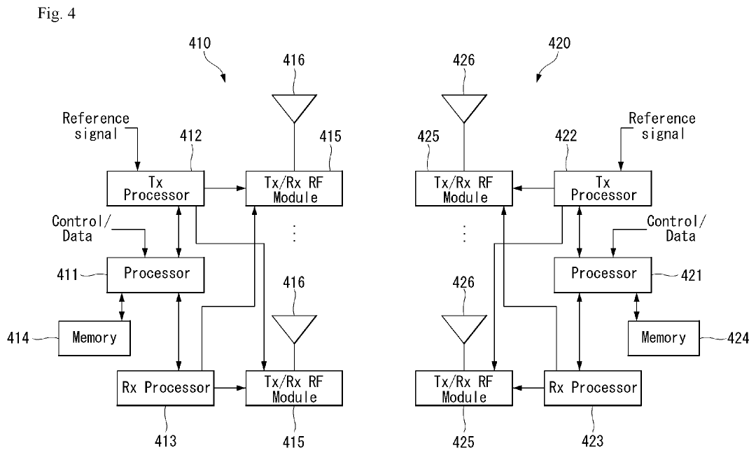

FIG. 4 illustrates a block diagram of a wireless communication system to which methods proposed in this specification are applicable.

Referring to FIG. 4, a drone is defined as a first communication device (910 of FIG. 4). A processor 911 may perform a detailed operation of the drone.

The drone may be represented as an unmanned aerial vehicle or an unmanned aerial robot.

A 5G network communicating with a drone may be defined as a second communication device (920 of FIG. 4). A processor 921 may perform a detailed operation of the drone. In this case, the 5G network may include another drone communicating with the drone.

A 5G network maybe represented as a first communication device, and a drone may be represented as a second communication device.

For example, the first communication device or the second communication device may be a base station, a network node, a transmission terminal, a reception terminal, a wireless apparatus, a wireless communication device or a drone.

For example, a terminal or a user equipment (UE) may include a drone, an unmanned aerial vehicle (UAV), a mobile phone, a smartphone, a laptop computer, a terminal for digital broadcasting, personal digital assistants (PDA), a portable multimedia player (PMP), a navigator, a slate PC, a tablet PC, an ultrabook, a wearable device (e.g., a watch type terminal (smartwatch), a glass type terminal (smart glass), and a head mounted display (HMD). For example, the HMD may be a display device of a form, which is worn on the head. For example, the HMD may be used to implement VR, AR or MR. Referring to FIG. 4, the first communication device 910, the second communication device 920 includes a processor 911, 921, a memory 914, 924, one or more Tx/Rx radio frequency (RF) modules 915, 925, a Tx processor 912, 922, an Rx processor 913, 923, and an antenna 916, 926. The Tx/Rx module is also called a transceiver. Each Tx/Rx module 915 transmits a signal each antenna 926. The processor implements the above-described function, process and/or method. The processor 921 may be related to the memory 924 for storing a program code and data. The memory may be referred to as a computer-readable recording medium. More specifically, in the DL (communication from the first communication device to the second communication device), the transmission (TX) processor 912 implements various signal processing functions for the L1 layer (i.e., physical layer). The reception (RX) processor implements various signal processing functions for the L1 layer (i.e., physical layer).

UL (communication from the second communication device to the first communication device) is processed by the first communication device 910 using a method similar to that described in relation to a receiver function in the second communication device 920. Each Tx/Rx module 925 receives a signal through each antenna 926. Each Tx/Rx module provides an RF carrier and information to the RX processor 923. The processor 921 may be related to the memory 924 for storing a program code and data. The memory may be referred to as a computer-readable recording medium.

Signal Transmission/Reception Method in Wireless Communication System

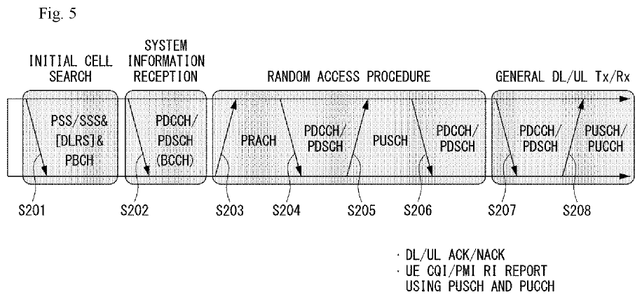

FIG. 5 is a diagram showing an example of a signal transmission/reception method in a wireless communication system.

Referring to FIG. 5, when power of a UE is newly turned on or the UE newly enters a cell, the UE performs an initial cell search task, such as performing synchronization with a BS (S201). To this end, the UE may receive a primary synchronization channel (P-SCH) and a secondary synchronization channel (S-SCH) from the BS, may perform synchronization with the BS, and may obtain information, such as a cell ID. In the LTE system and NR system, the P-SCH and the S-SCH are called a primary synchronization signal (PSS) and a secondary synchronization signal (SSS), respectively. After the initial cell search, the UE may obtain broadcast information within the cell by receiving a physical broadcast channel PBCH) form the BS. Meanwhile, the UE may identify a DL channel state by receiving a downlink reference signal (DL RS) in the initial cell search step. After the initial cell search is terminated, the UE may obtain more detailed system information by receiving a physical downlink control channel (PDCCH) and a physical downlink shared channel (PDSCH) based on information carried on the PDCCH (S202).

Meanwhile, if the UE first accesses the BS or does not have a radio resource for signal transmission, the UE may perform a random access procedure (RACH) on the BS (steps S203 to step S206). To this end, the UE may transmit a specific sequence as a preamble through a physical random access channel (PRACH) (S203 and S205), and may receive a random access response (RAR) message for the preamble through a PDSCH corresponding to a PDCCH (S204 and S206). In the case of a contention-based RACH, a contention resolution procedure may be additionally performed.

The UE that has performed the procedure may perform PDCCH/PDSCH reception (S207) and physical uplink shared channel (PUSCH)/physical uplink control channel (PUCCH) transmission (S208) as common uplink/downlink signal transmission processes. In particular, the UE receives downlink control information (DCI) through the PDCCH. The UE monitors a set of PDCCH candidates in monitoring occasions configured in one or more control element sets (CORESETs) on a serving cell based on corresponding search space configurations. A set of PDCCH candidates to be monitored by the UE is defined in the plane of search space sets. The search space set may be a common search space set or a UE-specific search space set. The CORESET is configured with a set of (physical) resource blocks having time duration of 1-3 OFDM symbols. A network may be configured so that the UE has a plurality of CORESETs. The UE monitors PDCCH candidates within one or more search space sets. In this case, the monitoring means that the UE attempts decoding on a PDCCH candidate(s) within the search space. If the UE is successful in the decoding of one of the PDCCH candidates within the search space, the UE determines that it has detected a PDCCH in a corresponding PDCCH candidate, and performs PDSCH reception or PUSCH transmission based on DCI within the detected PDCCH. The PDCCH may be used to schedule DL transmissions on the PDSCH and UL transmissions on the PUSCH. In this case, the DCI on the PDCCH includes downlink assignment (i.e., downlink (DL) grant) related to a downlink shared channel and at least including a modulation and coding format and resource allocation information, or an uplink (UL) grant related to an uplink shared channel and including a modulation and coding format and resource allocation information.

An initial access (IA) procedure in a 5G communication system is additionally described with reference to FIG. 5.

A UE may perform cell search, system information acquisition, beam alignment for initial access, DL measurement, etc. based on an SSB. The SSB is interchangeably used with a synchronization signal/physical broadcast channel (SS/PBCH) block.

An SSB is configured with a PSS, an SSS and a PBCH. The SSB is configured with four contiguous OFDM symbols. A PSS, a PBCH, an SSS/PBCH or a PBCH is transmitted for each OFDM symbol. Each of the PSS and the SSS is configured with one OFDM symbol and 127 subcarriers. The PBCH is configured with three OFDM symbols and 576 subcarriers.

Cell search means a process of obtaining, by a UE, the time/frequency synchronization of a cell and detecting the cell identifier (ID) (e.g., physical layer cell ID (PCI)) of the cell. A PSS is used to detect a cell ID within a cell ID group. An SSS is used to detect a cell ID group. A PBCH is used for SSB (time) index detection and half-frame detection.

There are 336 cell ID groups. 3 cell IDs are present for each cell ID group. A total of 1008 cell IDs are present. Information on a cell ID group to which the cell ID of a cell belongs is provided/obtained through the SSS of the cell. Information on a cell ID among the 336 cells within the cell ID is provided/obtained through a PSS.

An SSB is periodically transmitted based on SSB periodicity. Upon performing initial cell search, SSB base periodicity assumed by a UE is defined as 20 ms. After cell access, SSB periodicity may be set as one of {5 ms, 10 ms, 20 ms, 40 ms, 80 ms, 160 ms} by a network (e.g., BS).

Next, system information (SI) acquisition is described.

SI is divided into a master information block (MIB) and a plurality of system information blocks (SIBs). SI other than the MIB may be called remaining minimum system information (RMSI). The MIB includes information/parameter for the monitoring of a PDCCH that schedules a PDSCH carrying SysteminformationBlock1 (SIB1), and is transmitted by a BS through the PBCH of an SSB. SIB1 includes information related to the availability of the remaining SIBs (hereafter. SIBx, x is an integer of 2 or more) and scheduling (e.g., transmission periodicity, SI-window size). SIBx includes an SI message, and is transmitted through a PDSCH. Each SI message is transmitted within a periodically occurring time window (i.e., SI-window).

A random access (RA) process in a 5G communication system is additionally described with reference to FIG. 5.

A random access process is used for various purposes. For example, a random access process may be used for network initial access, handover, UE-triggered UL data transmission. A UE may obtain UL synchronization and an UL transmission resource through a random access process. The random access process is divided into a contention-based random access process and a contention-free random access process. A detailed procedure for the contention-based random access process is described below.

A UE may transmit a random access preamble through a PRACH as Msg1 of a random access process in the UL. Random access preamble sequences having two different lengths are supported. A long sequence length 839 is applied to subcarrier spacings of 1.25 and 5 kHz, and a short sequence length 139 is applied to subcarrier spacings of 15, 30, 60 and 120 kHz.

When a BS receives the random access preamble from the UE, the BS transmits a random access response (RAR) message (Msg2) to the UE. A PDCCH that schedules a PDSCH carrying an RAR is CRC masked with a random access (RA) radio network temporary identifier (RNTI) (RA-RNTI), and is transmitted. The UE that has detected the PDCCH masked with the RA-RNTI may receive the RAR from the PDSCH scheduled by DCI carried by the PDCCH. The UE identifies whether random access response information for the preamble transmitted by the UE, that is, Msg1, is present within the RAR. Whether random access information for Msg1 transmitted by the UE is present may be determined by determining whether a random access preamble ID for the preamble transmitted by the UE is present. If a response for Msg1 is not present, the UE may retransmit an RACH preamble within a given number, while performing power ramping. The UE calculates PRACH transmission power for the retransmission of the preamble based on the most recent pathloss and a power ramping counter.

The UE may transmit UL transmission as Msg3 of the random access process on an uplink shared channel based on random access response information. Msg3 may include an RRC connection request and a UE identity. As a response to the Msg3, a network may transmit Msg4, which may be treated as a contention resolution message on the DL. The UE may enter an RRC connected state by receiving the Msg4.

Beam Management (BM) Procedure of 5G Communication System

A BM process may be divided into (1) a DL BM process using an SSB or CSI-RS and (2) an UL BM process using a sounding reference signal (SRS). Furthermore, each BM process may include Tx beam sweeping for determining a Tx beam and Rx beam sweeping for determining an Rx beam.

A DL BM process using an SSB is described.

The configuration of beam reporting using an SSB is performed when a channel state information (CSI)/beam configuration is performed in RRC_CONNECTED.
A UE receives, from a BS, a CSI-ResourceConfig IE including CSI-SSB-ResourceSetList for SSB resources used for BM. RRC parameter csi-SSB-ResourceSetList indicates a list of SSB resources used for beam management and reporting in one resource set. In this case, the SSB resource set may be configured with {SSBx1, SSBx2, SSBx3, SSBx4, . . . }. SSB indices may be defined from 0 to 63.
The UE receives signals on the SSB resources from the BS based on the CSI-SSB-ResourceSetList.
If SSBRI and CSI-RS reportContig related to the reporting of reference signal received power (RSRP) have been configured, the UE reports the best SSBRI and corresponding RSRP to the BS. For example, if reportQuantity of the CSI-RS reportConfig IE is configured as “ssb-Index-RSRP”, the UE reports the best SSBRI and corresponding RSRP to the BS.

If a CSI-RS resource is configured in an OFDM symbol(s) identical with an SSB and “QCL-TypeD” is applicable, the UE may assume that the CSI-RS and the SSB have been quasi co-located (QCL) in the viewpoint of “QCL-TypeD.” In this case, QCL-TypeD may mean that antenna ports have been QCLed in the viewpoint of a spatial Rx parameter. The UE may apply the same reception beam when it receives the signals of a plurality of DL antenna ports having a QCL-TypeD relation.

Next, a DL BM process using a CSI-RS is described.

An Rx beam determination (or refinement) process of a UE and a Tx beam sweeping process of a BS using a CSI-RS are sequentially described. In the Rx beam determination process of the UE, a parameter is repeatedly set as “ON.” In the Tx beam sweeping process of the BS, a parameter is repeatedly set as “OFF.”

First, the Rx beam determination process of a UE is described.
The UE receives an NZP CSI-RS resource set IE, including an RRC parameter regarding “repetition”, from a BS through RRC signaling. In this case, the RRC parameter “repetition” has been set as “ON.”
The UE repeatedly receives signals on a resource(s) within a CSI-RS resource set in which the RRC parameter “repetition” has been set as “ON” in different OFDM symbols through the same Tx beam (or DL spatial domain transmission filter) of the BS.
The UE determines its own Rx beam.
The UE omits CSI reporting. That is, if the RRC parameter “repetition” has been set as “ON”, the UE may omit CSI reporting.

Next, the Tx beam determination process of a BS is described.
A UE receives an NZP CSI-RS resource set IE, including an RRC parameter regarding “repetition”, from the BS through RRC signaling. In this case, the RRC parameter “repetition” has been set as “OFF”, and is related to the Tx beam sweeping process of the BS.
The UE receives signals on resources within a CSI-RS resource set in which the RRC parameter “repetition” has been set as “OFF” through different Tx beams (DL spatial domain transmission filter) of the BS.
The UE selects (or determines) the best beam.
The UE reports, to the BS, the ID (e.g., CRI) of the selected beam and related quality information (e.g., RSRP). That is, the UE reports, to the BS, a CRI and corresponding RSRP, if a CSI-RS is transmitted for BM.

Next, an UL BM process using an SRS is described.
A UE receives, from a BS. RRC signaling (e.g., SRS-Config IE) including a use parameter configured (RRC parameter) as “beam management.” The SRS-Config IE is used for an SRS transmission configuration. The SRS-Config IE includes a list of SRS-Resources and a list of SRS-ResourceSets. Each SRS resource set means a set of SRS-resources.
The UE determines Tx beamforming for an SRS resource to be transmitted based on SRS-SpatialRelation Info included in the SRS-Config IE. In this case, SRS-SpatialRelation Info is configured for each SRS resource, and indicates whether to apply the same beamforming as beamforming used in an SSB. CSI-RS or SRS for each SRS resource.
If SRS-SpatialRelationInfo is configured in the SRS resource, the same beamforming as beamforming used in the SSB. CSI-RS or SRS is applied, and transmission is performed. However, if SRS-SpatialRelationInfo is not configured in the SRS resource, the UE randomly determines Tx beamforming and transmits an SRS through the determined Tx beamforming.

Next, a beam failure recovery (BFR) process is described.

In a beamformed system, a radio link failure (RLF) frequently occurs due to the rotation, movement or beamforming blockage of a UE. Accordingly, in order to prevent an RLF from occurring frequently, BFR is supported in NR. BFR is similar to a radio link failure recovery process, and may be supported when a UE is aware of a new candidate beam(s). For beam failure detection, a BS configures beam failure detection reference signals in a UE. If the number of beam failure indications from the physical layer of the UE reaches a threshold set by RRC signaling within a period configured by the RRC signaling of the BS, the UE declares a beam failure. After a beam failure is detected, the UE triggers beam failure recovery by initiating a random access process on a PCell, selects a suitable beam, and performs beam failure recovery (if the BS has provided dedicated random access resources for certain beams, they are prioritized by the UE). When the random access procedure is completed, the beam failure recovery is considered to be completed.

Ultra-Reliable and Low Latency Communication (URLLC)

URLLC transmission defined in NR may mean transmission for (1) a relatively low traffic size. (2) a relatively low arrival rate. (3) extremely low latency requirement (e.g., 0.5, 1 ms), (4) relatively short transmission duration (e.g., 2 OFDM symbols), and (5) an urgent service/message. In the case of the UL, in order to satisfy more stringent latency requirements, transmission for a specific type of traffic (e.g., URLLC) needs to be multiplexed with another transmission (e.g., eMBB) that has been previously scheduled. As one scheme related to this, information indicating that a specific resource will be preempted is provided to a previously scheduled UE, and the URLLC UE uses the corresponding resource for UL transmission.

In the case of NR, dynamic resource sharing between eMBB and URLLC is supported, eMBB and URLLC services may be scheduled on non-overlapping time/frequency resources. URLLC transmission may occur in resources scheduled for ongoing eMBB traffic. An eMBB UE may not be aware of whether the PDSCH transmission of a corresponding UE has been partially punctured. The UE may not decode the PDSCH due to corrupted coded bits. NR provides a preemption indication by taking this into consideration. The preemption indication may also be denoted as an interrupted transmission indication.

In relation to a preemption indication, a UE receives a DownlinkPreemption IE through RRC signaling from a BS. When the UE is provided with the DownlinkPreemption IE, the UE is configured with an INT-RNTI provided by a parameter int-RNTI within a DownlinkPreemption IE for the monitoring of a PDCCH that conveys DCI format 2_1. The UE is configured with a set of serving cells by INT-ConfigurationPerServing Cell, including a set of serving cell indices additionally provided by servingCellID, and a corresponding set of locations for fields within DCI format 2_1 by positionInDCI, configured with an information payload size for DCI format 2_1 by dci-PayloadSize. and configured with the indication granularity of time-frequency resources by timeFrequencySect.

The UE receives DCI format 2_1 from the BS based on the DownlinkPreemption IE.

When the UE detects DCI format 2_1 for a serving cell within a configured set of serving cells, the UE may assume that there is no transmission to the UE within PRBs and symbols indicated by the DCI format 2_1, among a set of the (last) monitoring period of a monitoring period and a set of symbols to which the DCI format 2_1 belongs. For example, the UE assumes that a signal within a time-frequency resource indicated by preemption is not DL transmission scheduled therefor, and decodes data based on signals reported in the remaining resource region.

Massive MTC (mMTC)

Massive machine type communication (mMTC) is one of 5G scenarios for supporting super connection service for simultaneous communication with many UEs. In this environment, a UE intermittently performs communication at a very low transmission speed and mobility. Accordingly, mMTC has a major object regarding how long will be a UE driven how low the cost is. In relation to the mMTC technology, in 3GPP, MTC and NarrowBand (NB)-IoT are handled.

The mMTC technology has characteristics, such as repetition transmission, frequency hopping, retuning, and a guard period for a PDCCH, a PUCCH, a physical downlink shared channel (PDSCH), and a PUSCH.

That is, a PUSCH (or PUCCH (in particular, long PUCCH) or PRACH) including specific information and a PDSCH (or PDCCH) including a response for specific information are repeatedly transmitted. The repetition transmission is performed through frequency hopping. For the repetition transmission. (RF) retuning is performed in a guard period from a first frequency resource to a second frequency resource. Specific information and a response for the specific information may be transmitted/received through a narrowband (e.g., 6 RB (resource block) or 1 RB).

Robot Basic Operation Using 5G Communication

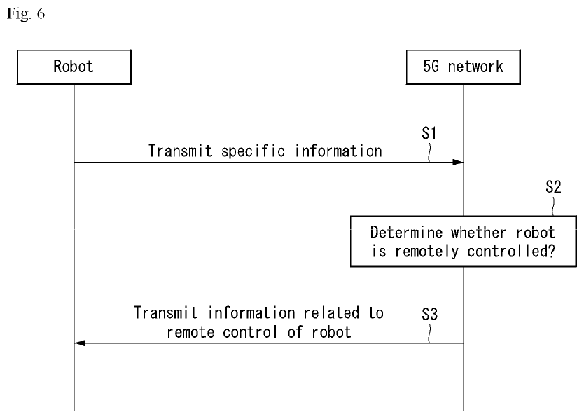

FIG. 6 shows an example of a basic operation of the robot and a 5G network in a 5G communication system.

A robot transmits specific information transmission to a 5G network (S1). Furthermore, the 5G network may determine whether the robot is remotely controlled (S2). In this case, the 5G network may include a server or module for performing robot-related remote control.

Furthermore, the 5G network may transmit, to the robot, information (or signal) related to the remote control of the robot (S3).

Application Operation Between Robot and 5G Network in 5G Communication System

Hereafter, a robot operation using 5G communication is described more specifically with reference to FIGS. 1 to 6 and the above-described wireless communication technology (BM procedure, URLLC, mMTC).

First, a basic procedure of a method to be proposed later in the present invention and an application operation to which the eMBB technology of 5G communication is applied is described.

As in steps S1 and S3 of FIG. 3, in order for a robot to transmit/receive a signal, information, etc. to/from a 5G network, the robot performs an initial access procedure and a random access procedure along with a 5G network prior to step S1 of FIG. 3.

More specifically, in order to obtain DL synchronization and system information, the robot performs an initial access procedure along with the 5G network based on an SSB. In the initial access procedure, a beam management (BM) process and a beam failure recovery process may be added. In a process for the robot to receive a signal from the 5G network, a quasi-co location (QCL) relation may be added.

Furthermore, the robot performs a random access procedure along with the 5G network for UL synchronization acquisition and/or UL. transmission. Furthermore, the 5G network may transmit an UL grant for scheduling the transmission of specific information to the robot. Accordingly, the robot transmits specific information to the 5G network based on the UL grant. Furthermore, the 5G network transmits, to the robot, a DL grant for scheduling the transmission of a 5G processing result for the specific information. Accordingly, the 5G network may transmit, to the robot, information (or signal) related to remote control based on the DL grant.

A basic procedure of a method to be proposed later in the present invention and an application operation to which the URLLC technology of 5G communication is applied is described below.

As described above, after a robot performs an initial access procedure and/or a random access procedure along with a 5G network, the robot may receive a DownlinkPreemption IE from the 5G network. Furthermore, the robot receives, from the 5G network, DCI format 2_1 including pre-emption indication based on the DownlinkPreemption IE. Furthermore, the robot does not perform (or expect or assume) the reception of eMBB data in a resource (PRB and/or OFDM symbol) indicated by the pre-emption indication. Thereafter, if the robot needs to transmit specific information, it may receive an UL grant from the 5G network.

A basic procedure of a method to be proposed later in the present invention and an application operation to which the mMTC technology of 5G communication is applied is described below.

A portion made different due to the application of the mMTC technology among the steps of FIG. 6 is chiefly described.

In step S1 of FIG. 6, the robot receives an UL grant from the 5G network in order to transmit specific information to the 5G network. In this case, the UL grant includes information on the repetition number of transmission of the specific information. The specific information may be repeatedly transmitted based on the information on the repetition number. That is, the robot transmits specific information to the 5G network based on the UL grant. Furthermore, the repetition transmission of the specific information may be performed through frequency hopping. The transmission of first specific information may be performed in a first frequency resource, and the transmission of second specific information may be performed in a second frequency resource. The specific information may be transmitted through the narrowband of 6 resource blocks (RBs) or 1 RB.

Operation Between Robots Using 5G Communication

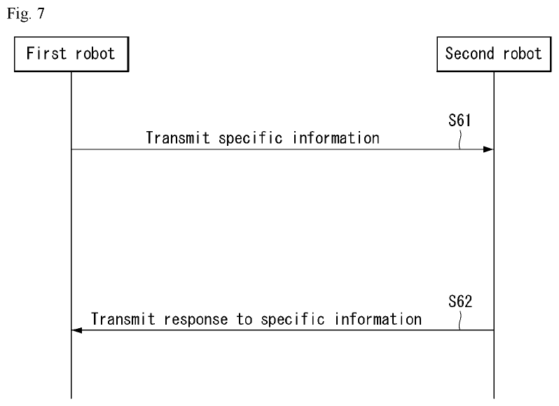

FIG. 7 illustrates an example of a basic operation between robots using 5G communication.

A first robot transmits specific information to a second robot (S61). The second robot transmits, to the first robot, a response to the specific information (S62).

Meanwhile, the configuration of an application operation between robots may be different depending on whether a 5G network is involved directly (sidelink communication transmission mode 3) or indirectly (sidelink communication transmission mode 4) in the specific information, the resource allocation of a response to the specific information.

An application operation between robots using 5G communication is described below.

First, a method for a 5G network to be directly involved in the resource allocation of signal transmission/reception between robots is described.

The 5G network may transmit a DCI format 5A to a first robot for the scheduling of mode 3 transmission (PSCCH and/or PSSCH transmission). In this case, the physical sidelink control channel (PSCCH) is a 5G physical channel for the scheduling of specific information transmission, and the physical sidelink shared channel (PSSCH) is a 5G physical channel for transmitting the specific information. Furthermore, the first robot transmits, to a second robot, an SCI format 1 for the scheduling of specific information transmission on a PSCCH. Furthermore, the first robot transmits specific information to the second robot on the PSSCH.

A method for a 5G network to be indirectly involved in the resource allocation of signal transmission/reception is described below.

A first robot senses a resource for mode 4 transmission in a first window. Furthermore, the first robot selects a resource for mode 4 transmission in a second window based on a result of the sensing. In this case, the first window means a sensing window, and the second window means a selection window. The first robot transmits, to the second robot, an SCI format 1 for the scheduling of specific information transmission on a PSCCH based on the selected resource. Furthermore, the first robot transmits specific information to the second robot on a PSSCH.

The above-described structural characteristic of the drone, the 5G communication technology, etc. may be combined with methods to be described, proposed in the present inventions, and may be applied or may be supplemented to materialize or clarify the technical characteristics of methods proposed in the present inventions.

Drone

Unmanned aerial system: a combination of a UAV and a UAV controller

Unmanned aerial vehicle: an aircraft that is remotely piloted without a human pilot, and it may be represented as an unmanned aerial robot, a drone, or simply a robot.

UAV controller: device used to control a UAV remotely

ATC: Air Traffic Control

NLOS: Non-line-of-sight

UAS: Unmanned Aerial System

UAV: Unmanned Aerial Vehicle

UCAS: Unmanned Aerial Vehicle Collision Avoidance System

UTM: Unmanned Aerial Vehicle Traffic Management

C2: Command and Control

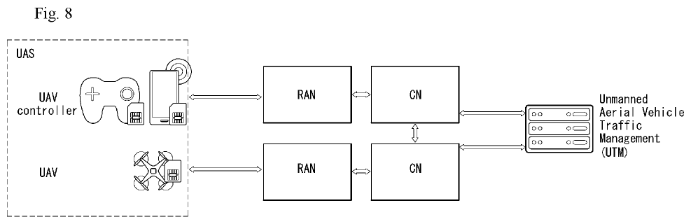

FIG. 8 is a diagram showing an example of the concept diagram of a 3GPP system including a UAS.

An unmanned aerial system (UAS) is a combination of an unmanned aerial vehicle (UAV), sometimes called a drone, and a UAV controller. The UAV is an aircraft not including a human pilot device. Instead, the UAV is controlled by a terrestrial operator through a UAV controller, and may have autonomous flight capabilities. A communication system between the UAV and the UAV controller is provided by the 3GPP system. In terms of the size and weight, the range of the UAV is various from a small and light aircraft that is frequently used for recreation purposes to a large and heavy aircraft that may be more suitable for commercial purposes. Regulation requirements are different depending on the range and are different depending on the area.

Communication requirements for a UAS include data uplink and downlink to/from a UAS component for both a serving 3GPP network and a network server, in addition to a command and control (C2) between a UAV and a UAV controller. Unmanned aerial system traffic management (UTM) is used to provide UAS identification, tracking, authorization, enhancement and the regulation of UAS operations and to store data necessary for a UAS for an operation. Furthermore, the UTM enables a certified user (e.g., air traffic control, public safety agency) to query an identity (ID), the meta data of a UAV, and the controller of the UAV.

The 3GPP system enables UTM to connect a UAV and a UAV controller so that the UAV and the UAV controller are identified as a UAS. The 3GPP system enables the UAS to transmit, to the UTM, UAV data that may include the following control information.

Control information: a unique identity (this may be a 3GPP identity), UE capability, manufacturer and model, serial number, take-off weight, location, owner identity, owner address, owner contact point detailed information, owner certification, take-off location, mission type, route data, an operating status of a UAV.

The 3GPP system enables a UAS to transmit UAV controller data to UTM. Furthermore, the UAV controller data may include a unique ID (this may be a 3GPP ID), the UE function, location, owner ID, owner address, owner contact point detailed information, owner certification, UAV operator identity confirmation, UAV operator license, UAV operator certification, UAV pilot identity, UAV pilot license, UAV pilot certification and flight plan of a UAV controller.

The functions of a 3GPP system related to a UAS may be summarized as follows.
A 3GPP system enables the UAS to transmit different UAS data to UTM based on different certification and an authority level applied to the UAS.
A 3GPP system supports a function of expanding UAS data transmitted to UTM along with future UTM and the evolution of a support application.
A 3GPP system enables the UAS to transmit an identifier, such as international mobile equipment identity (IMEI), a mobile station international subscriber directory number (MSISDN) or an international mobile subscriber identity (IMSI) or IP address, to UTM based on regulations and security protection.
A 3GPP system enables the UE of a UAS to transmit an identity, such as an IMEI. MSISDN or IMSI or IP address, to UTM.
A 3GPP system enables a mobile network operator (MNO) to supplement data transmitted to UTM, along with network-based location information of a UAV and a UAV controller.
A 3GPP system enables MNO to be notified of a result of permission so that UTM operates.
A 3GPP system enables MNO to permit a UAS certification request only when proper subscription information is present.
A 3GPP system provides the ID(s) of a UAS to UTM.
A 3GPP system enables a UAS to update UTM with live location information of a UAV and a UAV controller.
A 3GPP system provides UTM with supplement location information of a UAV and a UAV controller.
A 3GPP system supports UAVs, and corresponding UAV controllers are connected to other PLMNs at the same time.
A 3GPP system provides a function for enabling the corresponding system to obtain UAS information on the support of a 3GPP communication capability designed for a UAS operation.
A 3GPP system supports UAS identification and subscription data capable of distinguishing between a UAS having a UAS capable UE and a USA having a non-UAS capable UE.
A 3GPP system supports detection, identification, and the reporting of a problematic UAV(s) and UAV controller to UTM.

In the service requirement of Rel-16 ID_UAS, the UAS is driven by a human operator using a UAV controller in order to control paired UAVs. Both the UAVs and the UAV controller are connected using two individual connections over a 3GPP network for a command and control (C2) communication. The first contents to be taken into consideration with respect to a UAS operation include a mid-air collision danger with another UAV, a UAV control failure danger, an intended UAV misuse danger and various dangers of a user (e.g., business in which the air is shared, leisure activities). Accordingly, in order to avoid a danger in safety, if a 5G network is considered as a transmission network, it is important to provide a UAS service by QoS guarantee for C2 communication.

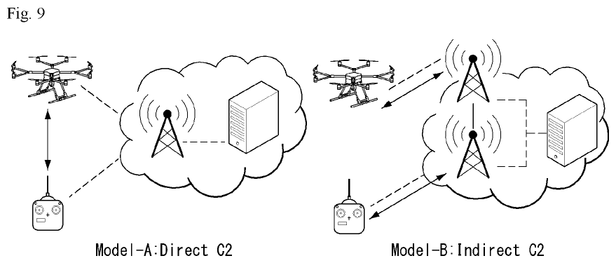

FIG. 9 shows examples of a C2 communication model for a UAV.

Model-A is direct C2. A UAV controller and a UAV directly configure a C2 link (or C2 communication) in order to communicate with each other, and are registered with a 5G network using a wireless resource that is provided, configured and scheduled by the 5G network, for direct C2 communication. Model-B is indirect C2. A UAV controller and a UAV establish and register respective unicast C2 communication links for a 5G network, and communicate with each other over the 5G network. Furthermore, the UAV controller and the UAV may be registered with the 5G network through different NG-RAN nodes. The 5G network supports a mechanism for processing the stable routing of C2 communication in any cases. A command and control use C2 communication for forwarding from the UAV controller/UTM to the UAV. C2 communication of this type (model-B) includes two different lower classes for incorporating a different distance between the UAV and the UAV controller/UTM, including a line of sight (VLOS) and a non-line of sight (non-VLOS). Latency of this VLOS traffic type needs to take into consideration a command delivery time, a human response time, and an assistant medium, for example, video streaming, the indication of a transmission waiting time. Accordingly, sustainable latency of the VLOS is shorter than that of the Non-VLOS. A 5G network configures each session for a UAV and a UAV controller. This session communicates with UTM, and may be used for default C2 communication with a UAS.

As part of a registration procedure or service request procedure, a UAV and a UAV controller request a UAS operation from UTM, and provide a pre-defined service class or requested UAS service (e.g., navigational assistance service, weather), identified by an application ID(s), to the UTM. The UTM permits the UAS operation for the UAV and the UAV controller, provides an assigned UAS service, and allocates a temporary UAS-ID to the UAS. The UTM provides a 5G network with information necessary for the C2 communication of the UAS. For example, the information may include a service class, the traffic type of UAS service, requested QoS of the permitted UAS service, and the subscription of the UAS service. When a request to establish C2 communication with the 5G network is made, the UAV and the UAV controller indicate a preferred C2 communication model (e.g., model-B) along with the UAS-ID allocated to the 5G network. If an additional C2 communication connection is to be generated or the configuration of the existing data connection for C2 needs to be changed, the 5G network modifies or allocates one or more QoS flows for C2 communication traffic based on requested QoS and priority in the approved UAS service information and C2 communication of the UAS.

UAV Traffic Management

(1) Centralized UAV Traffic Management

A 3GPP system provides a mechanism that enables UTM to provide a UAV with route data along with flight permission. The 3GPP system forwards, to a UAS, route modification information received from the UTM with latency of less than 500 ms. The 3GPP system needs to forward notification, received from the UTM, to a UAV controller having a waiting time of less than 500 ms.

(2) De-Centralized UAV Traffic Management
A 3GPP system broadcasts the following data (e.g., if it is requested based on another regulation requirement, UAV identities, UAV type, a current location and time, flight route information, current velocity, operation state) so that a UAV identifies a UAV(s) in a short-distance area for collision avoidance.
A 3GPP system supports a UAV in order to transmit a message through a network connection for identification between different UAVs. The UAV preserves owner's personal information of a UAV, UAV pilot and UAV operator in the broadcasting of identity information.
A 3GPP system enables a UAV to receive local broadcasting communication transmission service from another UAV in a short distance.
A UAV may use direct UAV versus UAV local broadcast communication transmission service in or out of coverage of a 3GPP network, and may use the direct UAV versus UAV local broadcast communication transmission service if transmission/reception UAVs are served by the same or different PLMNs.
A 3GPP system supports the direct UAV versus UAV local broadcast communication transmission service at a relative velocity of a maximum of 320 kmph. The 3GPP system supports the direct UAV versus UAV local broadcast communication transmission service having various types of message payload of 50-1500 bytes other than security-related message elements.
A 3GPP system supports the direct UAV versus UAV local broadcast communication transmission service capable of guaranteeing separation between UAVs. In this case, the UAVs may be considered to have been separated if they are in a horizontal distance of at least 50 m or a vertical distance of 30 m or both. The 3GPP system supports the direct UAV versus UAV local broadcast communication transmission service that supports the range of a maximum of 600 m.
A 3GPP system supports the direct UAV versus UAV local broadcast communication transmission service capable of transmitting a message with frequency of at least 10 message per second, and supports the direct UAV versus UAV local broadcast communication transmission service capable of transmitting a message whose inter-terminal waiting time is a maximum of 100 ms.
A UAV may broadcast its own identity locally at least once per second, and may locally broadcast its own identity up to a 500 m range.

Security

A 3GPP system protects data transmission between a UAS and UTM. The 3GPP system provides protection against the spoofing attack of a UAS ID. The 3GPP system permits the non-repudiation of data, transmitted between the UAS and the UTM, in the application layer. The 3GPP system supports the integrity of a different level and the capability capable of providing a personal information protection function with respect to a different connection between the UAS and the UTM, in addition to data transmitted through a UAS and UTM connection. The 3GPP system supports the classified protection of an identity and personal identification information related to the UAS. The 3GPP system supports regulation requirements (e.g., lawful intercept) for UAS traffic.

When a UAS requests the authority capable of accessing UAS data service from an MNO, the MNO performs secondary check (after initial mutual certification or simultaneously with it) in order to establish UAS qualification verification to operate. The MNO is responsible for transmitting and potentially adding additional data to the request so that the UAS operates as unmanned aerial system traffic management (UTM). In this case, the UTM is a 3GPP entity. The UTM is responsible for the approval of the UAS that operates and identities the qualification verification of the UAS and the UAV operator. One option is that the UTM is managed by an aerial traffic control center. The aerial traffic control center stores all data related to the UAV, the UAV controller, and live location. When the UAS fails in any part of the check, the MNO may reject service for the UAS and thus may reject operation permission.

3GPP Support for Aerial UE (or Drone) Communication

An E-UTRAN-based mechanism that provides an LTE connection to a UE capable of aerial communication is supported through the following functions.
Subscription-based aerial UE identification and authorization defined in Section TS 23.401, 4.3.31.
Height reporting based on an event in which the altitude of a UE exceeds a reference altitude threshold configured with a network.
Interference detection based on measurement reporting triggered when the number of configured cells (i.e., greater than 1) satisfies a triggering criterion at the same time.
Signaling of flight route information from a UE to an E-UTRAN.
Location information reporting including the horizontal and vertical velocity of a UE.

(1) Subscription-Based Identification of Aerial UE Function

The support of the aerial UE function is stored in user subscription information of an HSS. The HSS transmits the information to an MME in an Attach. Service Request and Tracking Area Update process. The subscription information may be provided from the MME to a base station through an S1 AP initial context setup request during the Attach, tracking area update and service request procedure. Furthermore, in the case of X2-based handover, a source base station (BS) may include subscription information in an X2-AP Handover Request message toward a target BS. More detailed contents are described later. With respect to intra and inter MME S1-based handover, the MME provides subscription information to the target BS after the handover procedure.

(2) Height-Based Reporting for Aerial UE Communication

An aerial UE may be configured with event-based height reporting. The aerial UE transmits height reporting when the altitude of the UE is higher or lower than a set threshold. The reporting includes height and a location.

(3) Interference Detection and Mitigation for Aerial UE Communication

For interference detection, when each (per cell) RSRP value for the number of configured cells satisfies a configured event, an aerial UE may be configured with an RRM event A3, A4 or A5 that triggers measurement reporting. The reporting includes an RRM result and location. For interference mitigation, the aerial UE may be configured with a dedicated UE-specific alpha parameter for PUSCH power control.

(4) Flight Route Information Reporting

An E-UTRAN may request a UE to report flight route information configured with a plurality of middle points defined as 3D locations, as defined in TS 36.355. If the flight route information is available for the UE, the UE reports a waypoint for a configured number. The reporting may also include a time stamp per waypoint if it is configured in the request and available for the UE.

(5) Location Reporting for Aerial UE Communication

Location information for aerial UE communication may include a horizontal and vertical velocity if they have been configured. The location information may be included in the RRM reporting and the height reporting.

Hereafter, (1) to (5) of 3GPP support for aerial UE communication is described more specifically.

DL/UL Interference Detection

For DL interference detection, measurements reported by a UE may be useful. UL interference detection may be performed based on measurement in a base station or may be estimated based on measurements reported by a UE. Interference detection can be performed more effectively by improving the existing measurement reporting mechanism. Furthermore, for example, other UE-based information, such as mobility history reporting, speed estimation, a timing advance adjustment value, and location information, may be used by a network in order to help interference detection. More detailed contents of measurement execution are described later.

DL Interference Mitigation

In order to mitigate DL interference in an aerial UE, LTE Release-13 FD-MIMO may be used. Although the density of aerial UEs is high, Rel-13 FD-MIMO may be advantageous in restricting an influence on the DL terrestrial UE throughput, while providing a DL aerial UE throughput that satisfies DL aerial UE throughput requirements. In order to mitigate DL interference in an aerial UE, a directional antenna may be used in the aerial UE. In the case of a high-density aerial UE, a directional antenna in the aerial UE may be advantageous in restricting an influence on a DL terrestrial UE throughput. The DL aerial UE throughput has been improved compared to a case where a non-directional antenna is used in the aerial UE. That is, the directional antenna is used to mitigate interference in the downlink for aerial UEs by reducing interference power from wide angles. In the viewpoint that a LOS direction between an aerial UE and a serving cell is tracked, the following types of capability are taken into consideration:

1) Direction of Travel (DoT): an aerial UE does not recognize the direction of a serving cell LOS, and the antenna direction of the aerial UE is aligned with the DoT.

2) Ideal LOS: an aerial UE perfectly tracks the direction of a serving cell LOS and pilots the line of sight of an antenna toward a serving cell.

3) Non-ideal LOS: an aerial UE tracks the direction of a serving cell LOS, but has an error due to actual restriction.

In order to mitigate DL interference with aerial UEs, beamforming in aerial UEs may be used. Although the density of aerial UEs is high, beamforming in the aerial UEs may be advantageous in restricting an influence on a DL terrestrial UE throughput and improving a DL aerial UE throughput. In order to mitigate DL interference in an aerial UE, intra-site coherent JT CoMP may be used. Although the density of aerial UEs is high, the intra-site coherent JT can improve the throughput of all UEs. An LTE Release-13 coverage extension technology for non-bandwidth restriction devices may also be used. In order to mitigate DL interference in an aerial UE, a coordinated data and control transmission method may be used. An advantage of the coordinated data and control transmission method is to increase an aerial UE throughput, while restricting an influence on a terrestrial UE throughput. It may include signaling for indicating a dedicated DL resource, an option for cell muting/ABS, a procedure update for cell (re)selection, acquisition for being applied to a coordinated cell, and the cell ID of a coordinated cell.

UL Interference Mitigation

In order to mitigate UL interference caused by aerial UEs, an enhanced power control mechanisms may be used. Although the density of aerial UEs is high, the enhanced power control mechanism may be advantageous in restricting an influence on a UL terrestrial UE throughput.

The above power control-based mechanism influences the following contents.
UE-specific partial pathloss compensation factor
UE-specific Po parameter
Neighbor cell interference control parameter
Closed-loop power control

The power control-based mechanism for UL interference mitigation is described more specifically.

1) UE-Specific Partial Pathloss Compensation Factor

The enhancement of the existing open-loop power control mechanism is taken into consideration in the place where a UE-specific partial pathloss compensation factor α_{UE} is introduced. Due to the introduction of the UE-specific partial pathloss compensation factor α_{UE} different α_{UE} may be configured by comparing an aerial UE with a partial pathloss compensation factor configured in a terrestrial UE.

2) UE-Specific P0 Parameter

Aerial UEs are configured with different Po compared with Po configured for terrestrial UEs. The enhance of the existing power control mechanism is not necessary because the UE-specific Po is already supported in the existing open-loop power control mechanism.

Furthermore, the UE-specific partial pathloss compensation factor α_{UE} and the UE-specific Po may be used in common for uplink interference mitigation. Accordingly, the UE-specific partial pathloss compensation factor α_{UE} and the UE-specific Po can improve the uplink throughput of a terrestrial UE, while scarifying the reduced uplink throughput of an aerial UE.

3) Closed-Loop Power Control

Target reception power for an aerial UE is coordinated by taking into consideration serving and neighbor cell measurement reporting. Closed-loop power control for aerial UEs needs to handle a potential high-speed signal change in the sky because aerial UEs may be supported by the sidelobes of base station antennas.

In order to mitigate UL interference attributable to an aerial UE. LTE Release-13 FD-MIMO may be used. In order to mitigate UL interference caused by an aerial UE, a UE-directional antenna may be used. In the case of a high-density aerial UE, a UE-directional antenna may be advantageous in restricting an influence on an UL terrestrial UE throughput. That is, the directional UE antenna is used to reduce uplink interference generated by an aerial UE by reducing a wide angle range of uplink signal power from the aerial UE. The following type of capability is taken into consideration in the viewpoint in which an LOS direction between an aerial UE and a serving cell is tracked:

1) Direction of Travel (DoT): an aerial UE does not recognize the direction of a serving cell LOS, and the antenna direction of the aerial UE is aligned with the DoT.

2) Ideal LOS: an aerial UE perfectly tracks the direction of a serving cell LOS and pilots the line of sight of the antenna toward a serving cell.

3) Non-ideal LOS: an aerial UE tracks the direction of a serving cell LOS, but has an error due to actual restriction.

A UE may align an antenna direction with an LOS direction and amplify power of a useful signal depending on the capability of tracking the direction of an LOS between the aerial UE and a serving cell. Furthermore, UL transmission beamforming may also be used to mitigate UL interference.

Mobility

Mobility performance (e.g., a handover failure, a radio link failure (RLF), handover stop, a time in Qout) of an aerial UE is weakened compared to a terrestrial UE. It is expected that the above-described DL and UL interference mitigation technologies may improve mobility performance for an aerial UE. Better mobility performance in a rural area network than in an urban area network is monitored. Furthermore, the existing handover procedure may be improved to improve mobility performance.
Improvement of a handover procedure for an aerial UE and/or mobility of a handover-related parameter based on location information and information, such as the aerial state of a UE and a flight route plan
A measurement reporting mechanism may be improved in such a way as to define a new event, enhance a trigger condition, and control the quantity of measurement reporting.

The existing mobility enhancement mechanism (e.g., mobility history reporting, mobility state estimation, UE support information) operates for an aerial UE and may be first evaluated if additional improvement is necessary. A parameter related to a handover procedure for an aerial UE may be improved based on aerial state and location information of the UE. The existing measurement reporting mechanism may be improved by defining a new event, enhancing a triggering condition, and controlling the quantity of measurement reporting. Flight route plan information may be used for mobility enhancement.

A measurement execution method which may be applied to an aerial UE is described more specifically.

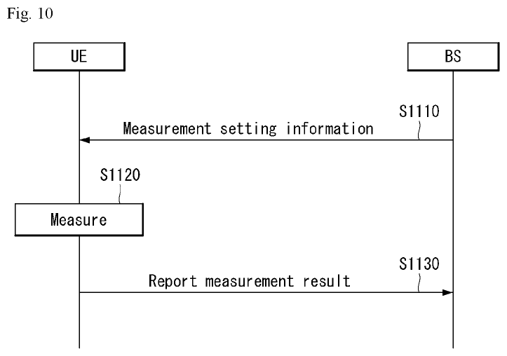

FIG. 10 is a flowchart showing an example of a measurement execution method to which the present invention may be applied.

An aerial UE receives measurement configuration information from a base station (S1010). In this case, a message including the measurement configuration information is called a measurement configuration message. The aerial UE performs measurement based on the measurement configuration information (S1020). If a measurement result satisfies a reporting condition within the measurement configuration information, the aerial UE reports the measurement result to the base station (S1030). A message including the measurement result is called a measurement report message. The measurement configuration information may include the following information.

(1) Measurement object information: this is information on an object on which an aerial UE will perform measurement. The measurement object includes at least one of an intra-frequency measurement object that is an object of measurement within a cell, an inter-frequency measurement object that is an object of inter-cell measurement, or an inter-RAT measurement object that is an object of inter-RAT measurement. For example, the intra-frequency measurement object may indicate a neighbor cell having the same frequency band as a serving cell. The inter-frequency measurement object may indicate a neighbor cell having a frequency band different from that of a serving cell. The inter-RAT measurement object may indicate a neighbor cell of an RAT different from the RAT of a serving cell.

(2) Reporting configuration information: this is information on a reporting condition and reporting type regarding when an aerial UE reports the transmission of a measurement result. The reporting configuration information may be configured with a list of reporting configurations. Each reporting configuration may include a reporting criterion and a reporting format. The reporting criterion is a level in which the transmission of a measurement result by a UE is triggered. The reporting criterion may be the periodicity of measurement reporting or a single event for measurement reporting. The reporting format is information regarding that an aerial UE will configure a measurement result in which type.

An event related to an aerial UE includes (i) an event H 1 and (ii) an event H2.

Event H1 (Aerial UE Height Exceeding a Threshold)

A UE considers that an entering condition for the event is satisfied when 1) the following defined condition H1-1 is satisfied, and considers that a leaving condition for the event is satisfied when 2) the following defined condition H1-2 is satisfied.

Ms−Hys>Thresh+Offset Inequality H1-1 (entering condition):

Ms+Hys<Thresh+Offset Inequality H1-2 (leaving condition):

In the above equation, the variables are defined as follows.

Ms is an aerial UE height and does not take any otffset into consideration. Hys is a hysteresis parameter (i.e., h1-hysteresis as defined in ReportConfigEUTRA) for an event. Thresh is a reference threshold parameter variable for the event designated in MeasConfig (i.e., heightThreshRef defined within MeasConfig). Offset is an offset value for heightThreshRef for obtaining an absolute threshold for the event (i.e., h1-ThresholdOffset defined in ReportConfigEUTRA). Ms is indicated in meters. Thresh is represented in the same unit as Ms.

Event H2 (Aerial UE Height of Less than Threshold)

A UE considers that an entering condition for an event is satisfied 1) the following defined condition H2-1 is satisfied, and considers that a leaving condition for the event is satisfied 2) when the following defined condition H2-2 is satisfied.

Ms+Hys<Thresh+Offset Inequality H2-1 (entering condition):

Ms−Hys>Thresh+Offset Inequality H2-2 (leaving condition):

In the above equation, the variables are defined as follows.

Ms is an aerial UE height and does not take any offset into consideration. Hys is a hysteresis parameter (i.e., h1-hysteresis as defined in ReportConfigEUTRA) for an event. Thresh is a reference threshold parameter variable for the event designated in MeasConfig (i.e., heightThreshRef defined within MeasConfig). Offset is an offset value for heightThreshRef for obtaining an absolute threshold for the event (i.e., h2-ThresholdOffset defined in ReportConfigEUTRA). Ms is indicated in meters. Thresh is represented in the same unit as Ms.

(3) Measurement identity information: this is information on a measurement identity by which an aerial UE determines to report which measurement object using which type by associating the measurement object and a reporting configuration. The measurement identity information is included in a measurement report message, and may indicate that a measurement result is related to which measurement object and that measurement reporting has occurred according to which reporting condition.

(4) Quantity configuration information: this is information on a parameter for configuring filtering of a measurement unit, a reporting unit and/or a measurement result value.

(5) Measurement gap information: this is information on a measurement gap, that is, an interval which may be used by an aerial UE in order to perform only measurement without taking into consideration data transmission with a serving cell because downlink transmission or uplink transmission has not been scheduled in the aerial UE.

In order to perform a measurement procedure, an aerial UE has a measurement object list, a measurement reporting configuration list, and a measurement identity list. If a measurement result of the aerial UE satisfies a configured event, the UE transmits a measurement report message to a base station.

In this case, the following parameters may be included in a UE-EUTRA-Capability Information Element in relation to the measurement reporting of the aerial UE. IE UE-EUTRA-Capability is used to forward, to a network, an E-RA UE Radio Access Capability parameter and a function group indicator for an essential function. IE UE-EUTRA-Capability is transmitted in an E-UTRA or another RAT. Table 1 is a table showing an example of the UE-EUTRA-Capability IE.

TABLE 1
--ASN1START..... MeasParameters-v1530 ::= SEQUENCE {qoe-MeasReport-r15
ENUMERATED {supported} OPTIONAL, qoe-MTSI-MeasReport-r15
ENUMERATED {supported} OPTIONAL, ca-IdleModeMeasurements-r15
ENUMERATED {supported} OPTIONAL, ca-IdleModeValidityArea-r15
ENUMERATED {supported} OPTIONAL, heightMeas-r15 ENUMERATED {supported}

| | |
|---|---|
| OPTIONAL, multipleCellsMeasExtension-r15 | ENUMERATED {supported} |

OPTIONAL}.....

The heightMeas-r15 field defines whether a UE supports height-based measurement reporting defined in TS 36.331. As defined in TS 23.401, to support this function with respect to a UE having aerial UE subscription is essential. The multipleCellsMeasExtension-r15 field defines whether a UE supports measurement reporting triggered based on a plurality of cells. As defined in TS 23.401, to support this function with respect to a UE having aerial UE subscription is essential.

UAV UE Identification

A UE may indicate a radio capability in a network which may be used to identify a UE having a related function for supporting a UAV-related function in an LTE network. A permission that enables a UE to function as an aerial UE in the 3GPP network may be aware based on subscription information transmitted from the MME to the RAN through S1 signaling. Actual “aerial use” certification/license/restriction of a UE and a method of incorporating it into subscription information may be provided from a Non-3GPP node to a 3GPP node. A UE in flight may be identified using UE-based reporting (e.g., mode indication, altitude or location information during flight, an enhanced measurement reporting mechanism (e.g., the introduction of a new event) or based on mobility history information available in a network.

Subscription Handling for Aerial UE

The following description relates to subscription information processing for supporting an aerial UE function through the E-UTRAN defined in TS 36.300 and TS 36.331. An eNB supporting aerial UE function handling uses information for each user, provided by the MME, in order to determine whether the UE can use the aerial UE function. The support of the aerial UE function is stored in subscription information of a user in the HSS. The HSS transmits the information to the MME through a location update message during an attach and tracking area update procedure. A home operator may cancel the subscription approval of the user for operating the aerial UE at any time. The MME supporting the aerial UE function provides the eNB with subscription information of the user for aerial UE approval through an S1 AP initial context setup request during the attach, tracking area update and service request procedure.

An object of an initial context configuration procedure is to establish all required initial UE context, including E-RAB context, a security key, a handover restriction list, a UE radio function, and a UE security function. The procedure uses UE-related signaling.

In the case of Inter-RAT handover to intra- and inter-MME S1 handover (intra RAT) or E-UTRAN, aerial UE subscription information of a user includes an S1-AP UE context modification request message transmitted to a target BS after a handover procedure.

An object of a UE context change procedure is to partially change UE context configured as a security key or a subscriber profile ID for RAT/frequency priority, for example. The procedure uses UE-related signaling.

In the case of X2-based handover, aerial UE subscription information of a user is transmitted to a target BS as follows:
If a source BS supports the aerial UE function and aerial UE subscription information of a user is included in UE context, the source BS includes corresponding information in the X2-AP handover request message of a target BS.
An MME transmits, to the target BS, the aerial UE subscription information in a Path Switch Request Acknowledge message.

An object of a handover resource allocation procedure is to secure, by a target BS, a resource for the handover of a UE.

If aerial UE subscription information is changed, updated aerial UE subscription information is included in an S1-AP UE context modification request message transmitted to a BS.

Table 2 is a table showing an example of the aerial UE subscription information.

TABLE 2

| | | | |
|---|---|---|---|
| IE/Group Name | Presence | Range | IE type and reference |

| | | |
|---|---|---|
| Aerial UE | M | ENUMERATED (allowed, |
| subscription | | not allowed, . . .) |
| information | | |

Aerial UE subscription information is used by a BS in order to know whether a UE can use the aerial UE function.

Combination of Drone and eMBB

A 3GPP system can support data transmission for a UAV (aerial UE or drone) and for an eMBB user at the same time.

A base station may need to support data transmission for an aerial UAV and a terrestrial eMBB user at the same time under a restricted bandwidth resource. For example, in a live broadcasting scenario, a UAV of 100 meters or more requires a high transmission speed and a wide bandwidth because it has to transmit, to a base station, a captured figure or video in real time. At the same time, the base station needs to provide a requested data rate to terrestrial users (e.g., eMBB users). Furthermore, interference between the two types of communications needs to be minimized.

Due to a limited battery capacity, because a flight time of a drone is limited to a predetermined time (e.g., 2 to 30 minutes), the flight time is somewhat a short time to perform a specific service or operation, and when the drone is operated, the drone may fall due to battery shortage.

Therefore, stations for charging the drone may be disposed at a predetermined gap, but when the drone does not return to the station capable of charging due to battery shortage, a user should directly reach and collect at a position in which the drone has stopped due to battery shortage.

Further, a charging and return system of the drone is currently insufficient.

For example, in the case of a drone for monitoring a predetermined region, while performing a monitoring operation, a hovering operation of stopping at and observing a particular region in the air consumes excessively much power.

In order to solve such problems, the present invention provides a method in which a drone lands at a position (hereinafter, referred to as an outer wall) perpendicular to the ground to perform a monitoring operation in order to reduce hovering power of the drone.

The present invention further provides a method of solving a safety problem that occurs as a drone flies in a direction perpendicular to the ground when the drone performs emergency landing on an outer wall.

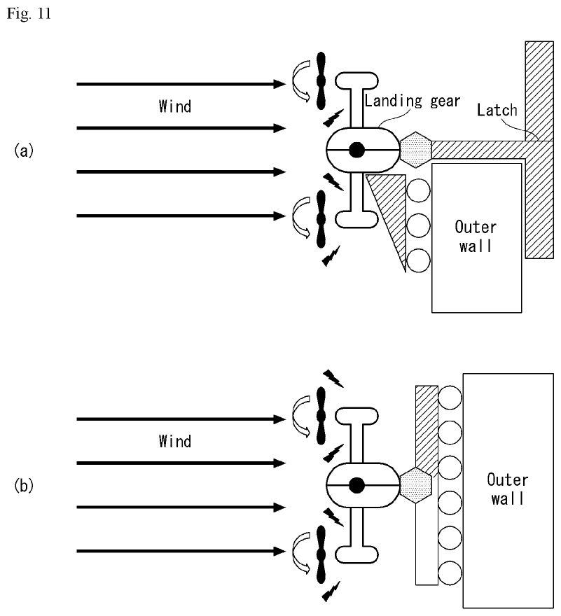

FIG. 11 is a diagram illustrating an example of a structure in which a drone lands at a position perpendicular to the ground according to an embodiment of the present invention

Referring to FIG. 11, when the drone wants to land at a position perpendicular to the ground, the drone may land using a suction method on a wall surface or a latch in a landing leg or a landing gear.

The position perpendicular to the ground may exist at a cliff, an outer wall of a building, a window, or a tree, but in the present invention, the position is collectively referred to as an outer wall. However, the present invention is not limited thereto, and the outer wall may be referred to as a position perpendicular to the ground such as a cliff an outer wall of a building, a window, or a tree.

Specifically, when the drone lands on the ground, the drone may attempt to safely land using a landing leg or a landing gear, but when the drone lands on an outer wall, if the drone uses a general landing leg or landing gear, stability may be deteriorated.

Therefore, in order for the drone to land on the outer wall, a separate method of securely fixing the drone to the outer wall is required. For example, as illustrated in FIG. 1l(a), the drone may be provided with a separate landing gear and latch and securely fix the main body to the outer wall through the landing gear and the latch.

Alternatively, as illustrated in FIG. 11(b), the drone may be provided with a separate specific device for securely securing the main body to the outer wall, thereby landing on the outer wall.

For example, by securely fixing each landing leg to the outer wall using a suction sucker or an adhesive method, the drone may land on the outer wall.

The present invention provides a method in which a drone performs a specific operation using such a method of landing the drone on an outer wall.

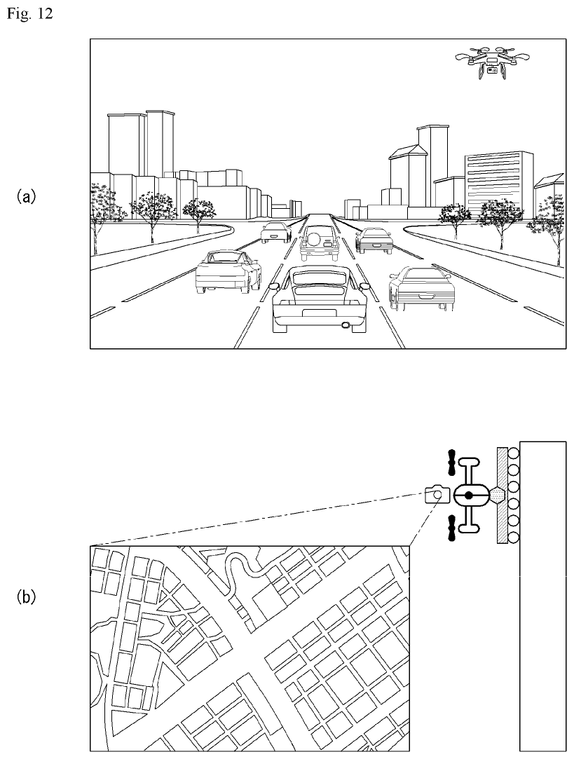

FIG. 12 is a diagram illustrating an example of a monitoring method of a drone according to an embodiment of the present invention.

Referring to FIG. 12, the drone may perform a monitoring operation without a separate hovering motion by fixing a main body to the outer wall.

Specifically, referring to FIG. 12(a), when the drone generally performs a monitoring operation while flying a predetermined area, in order to intensively monitor a specific area, the drone should perform a monitoring operation through a camera while stopping the flight.

That is, in order to perform a monitoring operation in flight, the drone should photograph for the monitoring operation without moving in a state floated in the air. Hovering is a state in which a drone floats without moving in the air.

However, in order for the drone to perform a hovering operation, a propeller should continuously rotate, and such an operation has a problem that a battery of the drone is excessively consumed.

However, as illustrated in FIG. 111(b), when the drone lands on the outer wall during flight, the drone may monitor a predetermined region without a separate hovering operation. That is, as the drone lands at a high outer wall, the drone may perform a monitoring operation through the camera, and in such a case, because a separate hovering operation is not performed, power consumption of the drone can be reduced.

Hereinafter, a specific method in which the drone lands on an outer wall will be described.

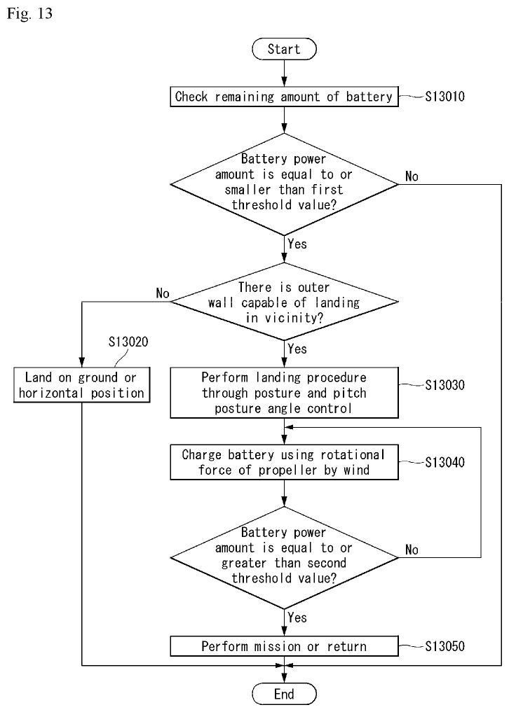

FIG. 13 is a flowchart illustrating an example of a method in which a drone lands at a position perpendicular to the ground and performs a specific operation according to an embodiment of the present invention.

Referring to FIG. 13, the drone may control a posture pitch angle and a propeller rotation to land on the outer wall. Hereinafter, because the drone operates through a rotation of the propeller, the drone may be referred to as a rotary wing unmanned aerial robot.

Specifically, the drone may depart from a station or a departure point and perform a predetermined service or mission while flying. For example, the drone may perform an operation of monitoring a predetermined area through a camera sensor while moving to a predetermined destination or flying a predetermined range.

The drone may check the remaining amount of the battery while performing such an operation or mission (S13010).

The drone may check periodically or non-periodically the remaining battery amount in a particular situation, and determine whether the remaining battery amount is smaller than a threshold value (first threshold value).

In this case, the first threshold value may mean a minimum amount of battery for the drone to perform a particular operation or mission. If the remaining battery amount is smaller than the first threshold value, the battery may not move to a specific destination or a charging station and may fall.

Therefore, if the remaining battery amount is greater than the first threshold value, the drone may still perform a specific operation and thus the drone may continue to perform the performing mission or operation.

However, if the battery remaining amount is smaller than the first threshold value, the drone searches for an outer wall capable of landing at an adjacent position for landing. In this case, the outer wall capable of landing may be recognized through an image sensor or an ultrasonic sensor provided in the drone.

If there is no outer wall capable of landing in the vicinity of the flying drone, the drone may land on the ground or a horizontal position using a general landing method (S13020).

However, if there is an outer wall capable of landing in the vicinity, the drone may attempt to land on the outer wall, and in this case, the method described with reference to FIG. 11 may be used.

Specifically, in order to land on the outer wall using the method described with reference to FIG. 11, the drone may control a posture and a pitch posture angle using a rotation of the propeller to land on the outside wall (S13030).

In this case, in order for the drone to attach a landing leg or a landing gear to the outer wall, a posture pitch angle, which is an angle between the drone and the ground, should be a vertical angle (90°), and for this purpose, a rotational force of the propeller may be used.

That is, by differently controlling a rotation speed or a rotation direction of each of a plurality of propellers attached to the main body, the drone may increase a posture pitch angle, and when the posture pitch angle becomes a value perpendicular to the ground, the drone may land on the outer wall.

A method in which the drone lands on the outer wall by performing a landing procedure using a posture and a pitch posture angle will be described in detail hereinafter.

Thereafter, the drone may charge a battery by operating a motor using a rotational force of the propeller rotating by the wind (S13040). For this reason, the drone may sense a wind direction and a wind speed through the sensor and turn off the propeller and thus the propeller may be rotated by the wind.

The drone may continue to charge using the wind until a power amount of the battery is equal to or larger than a specific threshold value (second threshold value), and the remaining amount of the battery may be checked continuously or periodically.

If the remaining amount of the battery is smaller than the second threshold value, the drone may continue to charge, and if the remaining amount of the battery is larger than the second threshold value, the drone may stop charging and continue to perform the stopped mission or service (S13050).

In this case, the second threshold value may mean a minimum amount of power for the drone to perform the remaining service or mission and to fly to a station or a destination.

With such a method, by performing emergency landing on the outer wall in the case of an emergency situation (battery shortage), automatic charging of the drone may be performed, and hovering power required for a monitoring mission can be saved.

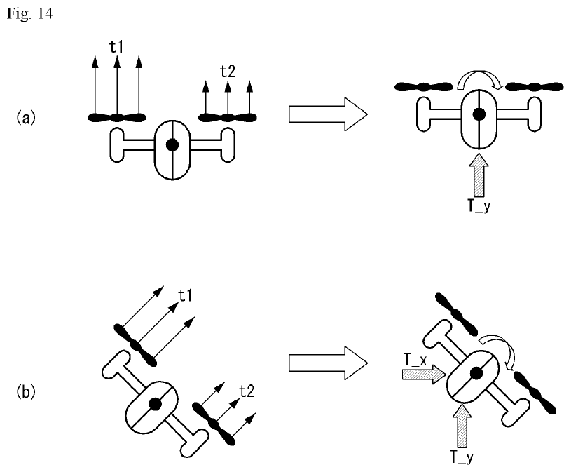

FIG. 14 is a diagram illustrating an example of a control method according to an embodiment of the present invention.

As illustrated in FIG. 14, the drone generally performs an upward movement using a rotational force generated by a rotation of the propeller.

That is, the drone may generate a speed of a vertical axis (hereinafter, y-axis) through a rotation of the propeller and control a speed of each of the propellers to perform a direction change and a rotation motion.

For example, as shown in FIG. 14(a), by increasing a rotational speed of a left propeller, when a rotational force of t1 becomes larger than t2, the drone rotates clockwise.

If the rotational forces of t1 and t2 become equal to each other as shown in FIG. 14(b) during the rotation, the drone moves to an inclined state because T_x, which is a force of an x-axis and T_y, which is a force of a y-axis are equal to each other.

That is, in FIG. 14(b), the drone moves in an upward diagonal direction.

However, it is difficult for the drone to land through such control. That is, because the drone receives a force and moves in only one direction, it is difficult to increase a pitch posture angle to a vertical angle in order to land the drone on a wall surface, and in a state in which the drone is perpendicular to the ground, because the drone tries to move in an opposite direction of the outer wall, it is difficult to attach the drone to a wall surface.

Hereinafter, a control method of moving the drone in a descending direction as well as an ascending direction by controlling the propeller of the drone to rotate in a reverse direction will be described.

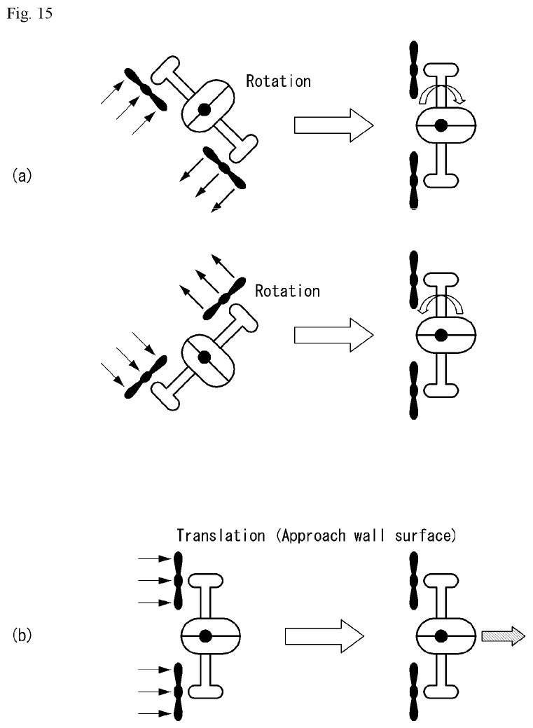

FIG. 15 is a diagram illustrating an example of another control method according to an embodiment of the present invention.

Referring to FIG. 15, by controlling some of propellers of the drone to perform a reverse rotation, a posture pitch angle of the drone may be effectively controlled, and the drone may be controlled to easily approach to the outer wall.

Specifically, when the propeller of the drone rotates only in a forward direction, in order to land the drone on the outer wall as described with reference to FIG. 14, it is difficult to control a direction of the drone to be parallel to the outer wall.

However, as show n in FIG. 15(a), when some of a plurality of propellers of the drone are controlled to rotate in a forward direction and some thereof are controlled to rotate in a reverse direction, a posture pitch angle of the drone may be easily controlled.

For example, when the pitch posture angle of the drone is greater than 90°, if the upper propeller is controlled to perform a reverse rotation and the lower propeller is controlled to perform a forward rotation, an angle of the drone may be quickly controlled.

That is, when the propeller of the drone rotates in a forward direction, a force to ascend occurs, and when the propeller of the drone rotates in a reverse direction, a force to descend occurs and thus a pitch posture angle of the drone may be quickly modified.

Alternatively, when the pitch posture angle of the drone is smaller than 90°, if the upper propeller is controlled to perform a forward rotation and the lower propeller is controlled to perform a reverse rotation, an angle of the drone may be quickly controlled.

When using such a method, in order for the drone to first land on the outer wall, when a pitch posture angle is increased and when a posture pitch angle of the drone is changed after the drone is perpendicular to the ground and is parallel to the outer wall, an angle of the drone may be quickly modified.

Further, after a posture pitch angle of the drone becomes 90°, in order for the drone to approach a wall surface, the propeller should rotate in a reverse direction, as shown in FIG. 15(b).

That is, in order for the drone to approach an outer wall in a vertical state, a force should occur inward the propeller. For this reason, the propeller should perform a reverse rotation, not a forward rotation, and thus the drone may generate a force inward the propeller and approach the outer wall.

In this way, with a method described with reference to FIGS. 15(a) and 15(b), the drone may approach the outer wall and when the drone approaches the outer wall, the drone may land on the outer wall using a landing leg or a landing gear.

In this case, in order to be securely fastened to the outer wall, the drone may use a latch, an adhesive method, or a suction method.

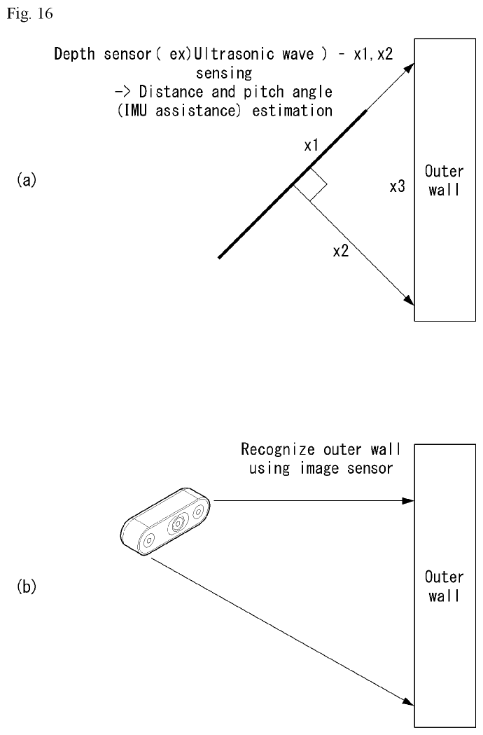

FIG. 16 is a diagram illustrating an example of a method in which a drone recognizes an outer wall according to an embodiment of the present invention.

Referring to FIG. 16, the drone may recognize whether an outer wall is an outer wall capable of landing through a sensor provided in the main body.

Specifically, the drone may recognize an outer wall and a distance to the outer wall through at least one sensor provided in the main body. That is, when the drone recognizes an outer wall capable of landing through at least one sensor, by calculating a distance to the outer wall, the drone may attempt to land to the outer wall.

In this case, in order to control landing of the drone using a distance and a pitch posture angle of the drone, as at least one sensor, an ultrasonic sensor or a depth sensor may be used. Further, a position of the outer wall and a distance to the outer wall may be calculated through an image of video.

For example, as illustrated in FIG. 16(a), the drone may measure a distance from each sensor to the outer wall using a depth sensor or an ultrasonic sensor, and the drone may clearly calculate (or recognize) a straight line distance from the drone to the outer wall based on the distance measured from each sensor.

Alternatively, as illustrated in FIG. 16(b), the drone may recognize an adjacent outer wall using an image sensor and determine whether a recognized outer wall is an outer wall capable of landing.

In this case, the drone may calculate a distance to the outer wall through an image or video using the image sensor and recognize a pattern or a curvature of the outer wall itself to perform a landing procedure thereof.

Therefore, the drone may recognize an adjacent outer wall capable of landing through at least one sensor provided therein and recognize a distance to the recognized outer wall and a curvature of the outer wall to attempt to land.

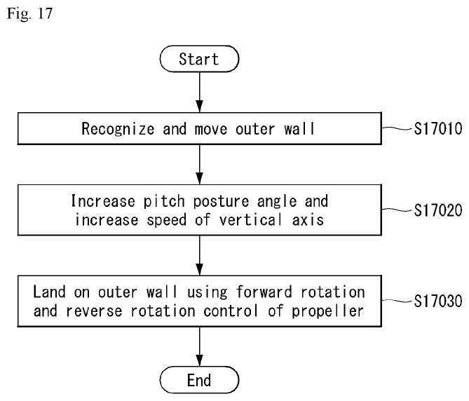

FIG. 17 is a flowchart illustrating an example of a method in which a drone lands at a position perpendicular to the ground according to an embodiment of the present invention.

Referring to FIG. 17, the drone may recognize an adjacent outer wall capable of landing and control a forward rotation and a reverse rotation of the propeller to land the outer wall through pitch posture angel adjustment of the drone and a movement of the drone to the outer wall.

Specifically, while the drone takes off from the station and performs an operation (e.g., monitoring) for a specific purpose, as shown in FIG. 13, when the drone lands on an outer wall due to a problem such as a battery, the drone recognizes an adjacent outer wall capable of landing through the method described with reference to FIG. 16 and approaches the outer wall (S17010).

When the drone lands on the outer wall, the drone uses only power of a direction opposite to the outer wall and thus while the drone approaches the outer wall, the drone may increase a speed of an outer wall direction.

Thereafter, when a distance to the outer wall is within a predetermined distance, in order to perform a landing procedure to the outer wall, the drone may increase a pitch posture angle and increase a speed of the vertical axis to ascend (S17020).

That is, in order to facilitate landing on the outer wall, the drone increases a pitch posture angle and increases Vy, which is a y-axis speed in order to perform soft landing at a point in which a y-axis speed is 0.

In this case, the pitch posture angle may increase to 90°, and the pitch posture angle of the drone may be maintained to 90° through the method described with reference to FIG. 15.

Thereafter, the drone may control a forward rotation and a reverse rotation of the propeller in a state parallel to the outer wall, thereby landing on the outer wall (S17030).

Specifically, as described with reference to FIG. 15(b), the drone may control the propeller to perform a reverse rotation in a state of being horizontal with the outer wall to approach to the outer wall through a translational motion, and when the drone reaches the outer wall, the drone may be fixed to the outer wall through the above-described method.

In this case, while the drone approaches to the outer wall through a translational motion, if a pitch posture angle is smaller than or larger than 90°, the drone may control a forward rotation and/or a reverse rotation of each of a plurality of propellers to control a pitch posture angle to be 90°, as described with reference to FIG. 15(a).

When the drone arrives the outer wall and attempts to land, by enabling propellers located at an upper portion to perform a reverse rotation faster than the propellers located at a lower portion among a plurality of propellers, the drone may be prevented from falling in a process of being attached to the outer wall.

Thereafter, when the drone is fixed to the outer wall, the drone may turn off propellers and monitor a predetermined region or may charge a battery using a propeller rotating by the wind.

Alternatively, a monitoring operation and a charging operation may be simultaneously performed.

Thereafter, when charging is completed, the drone may fly again and complete a predetermined mission, and when the mission is completed, the drone may return to a station or a control center.

In this way, when the drone lands on an outer wall using landing using an inertial force and a landing gear in contact with the outer wall, by landing on the outer wall in an emergency situation (battery shortage), automatic charging of the drone is available, and by performing a monitoring mission in a state attached to the outer wall, power consumed for hovering can be saved.

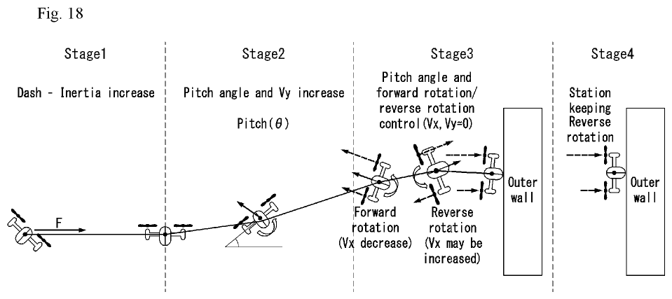

FIG. 18 is a flowchart illustrating another example of a method in which a drone lands at a position perpendicular to the ground according to an embodiment of the present invention.

Referring to FIG. 18, when landing on the outer wall through the control of a forward rotation and a reverse rotation of the propeller, the drone may attempt to land at a point in which a vertical axis speed is 0.

Specifically, Stage 1: when the drone attempts to land on the outer wall, the drone recognizes an adjacent outer wall capable of landing with the method described with reference to FIG. 16 and approaches the outer wall.

In this case, when the drone attempts to land on the outer wall, the drone uses a force in an opposite direction of the outer wall and thus the drone may increase a speed in the outer wall direction while approaching the outer wall.

In this case, a resultant force F for increasing a speed of the drone in the x-axis at Stage 1 may be calculated by Equation 1.

\vec{F}(resultant)=\vec{T}(probe trust)+\vec{g}(gravity)

Y direction force: F_{y}=T sin 0−mg=F sin 0

F direction force: F_{y}=T cos 0=T cos 0[Equation1]

Stage 2: Thereafter, when a distance between the drone and the outer wall is close to a distance within a predetermined distance, in order to perform a landing procedure to the outer wall, by increasing a pitch angle of the drone and increasing a speed of the vertical axis, the drone may ascend.

That is, in order to facilitate landing on the outer wall, the drone increases a pitch posture angle, and at a point in which a y-axis speed is 0, in order to perform soft landing, the drone increases Vy, which is a speed to a y-axis.

In this case, Vy may be calculated through Equation 2.

$$Y direction speed : Vy = v 0 ( initial speed = 0 ) + \int F\_ydt ) = \int ( T sin θ - mg ) dt = \int ( T sin θ ) dt - mg\_td = 0 -> \begin{matrix}{t}_{td} = ( {\int }_{0}^{t \_td} T sin θ dt ) \text{/} mg \\ ( touch down consumption time )\end{matrix} \qquad [ Equation 2 ]$$

In this case, the pitch posture angle may increase to 90° and then the pitch posture angle of the drone may be maintained to 90° through the method described with reference to FIG. 15.

Stage 3: the drone may control a forward rotation and a reverse rotation of the propeller in a state parallel to the outer wall, thereby landing on the outer wall. Specifically, in a state horizontal with the outer wall, as described with reference to FIG. 15(b), the drone may control the propeller to rotate in a reverse direction to approach to the outer wall through a translational motion and when the drone reaches the outer wall, the drone may be fixed to the outer wall through the above-described method.

In this case, at a point in which Vy, which is a speed of a Y-axis is “0”, the drone may attempt to land through a forward rotation and a reverse rotation of the propeller, and a position in which Vy becomes “0” may be calculated through Equation 3.

Y direction speed: Y=Y0(initial speed)+∫₀^{t_td}Vydt →Y0(initial position)+∫₀^{t_td}(∫₀^{t_td}(T sin θ)dt−mgt_td)dt[Equation 31]
(point in which a vertical speed becomes 0)

In this case, while the drone approaches the outer wall through a translational motion, when the pitch posture angle is smaller than or larger than 90°, as described with reference to FIG. 15(a), the drone may control a forward rotation and/or a reverse rotation of each of a plurality of propellers to control the pitch posture angle to be 90°.

When the drone reaches the outer wall and attempts landing, even if landing is failed, in order to prevent the drone from falling, Revolutions Per Minute (RPM) of at least one upper propeller, i.e., a propeller in a sky direction may be stronger than that of at least one propeller of the low end.

In this case, even if the drone fails to land on the outer wall, the drone is separated from the outer wall or rotates counterclockwise not to be turned over and thus the drone may normally fly again without falling.

When the drone reaches the outer wall and attempts to land, the drone may use the latch described with reference to FIG. 11.

Thereafter, the drone may land on the outer wall to perform a specific operation (monitoring of a predetermined area, etc.) or mission in a fixed state, and after the propeller is turned off, the drone may charge the battery using a rotational force of the propeller by the wind.

Further, when charging of the battery is complete, the drone may fly again to a destination or may return to a control center or a station of a point of departure.

Further, because a point and a time in which the drone is consumed for reaching the outer wall may be dependent on a pitch posture angle, an expected landing point of the drone may be calculated by sensing the pitch posture angle in real time in a landing process at the outer wall.

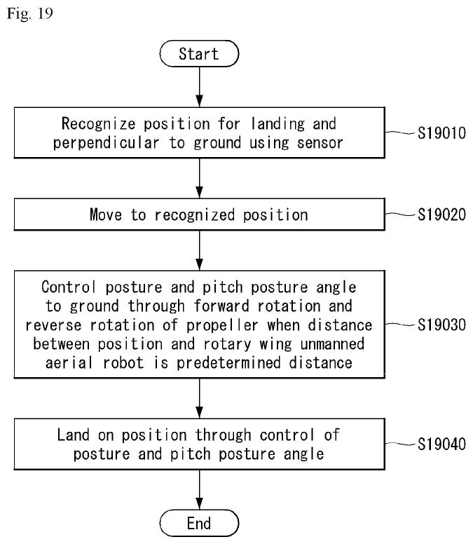

FIG. 19 is a flowchart illustrating an example of a method of landing by controlling a posture of a drone and a rotation of a propeller according to an embodiment of the present invention.

Referring to FIG. 19, the drone may recognize a position for landing and perpendicular to the ground using a sensor (S19010). In this case, the sensor may use the sensor and recognition methods described with reference to FIG. 16.

Thereafter, as described with reference to FIGS. 17 and 18, the drone may move to a recognized position through a forward rotation of the propeller (S19020).

Thereafter, when the drone approaches within a predetermined distance from the outer wall, the drone may be parallel to the outer wall through the control of a posture and a pitch posture angle to the ground by a forward rotation and a reverse rotation of the propeller.

In this case, as described with reference to FIGS. 15 to 18, in order to perform a landing procedure to an outer wall, the drone may increase a pitch posture angle and ascend by increasing a speed of a vertical axis.

That is, in order to facilitate landing on the outer wall, the drone may increase a pitch posture angle, and in order to perform soft landing at a point in which a y-axis speed is 0, Vy, which is a speed to y-axis is increased.

In this case, the pitch posture angle may increase to 90°, and the pitch posture angle of the drone may be maintained to 90° through the method described with reference to FIG. 15.

Thereafter, the drone may land at a specific position of the outer wall through the control of a posture and a pitch posture angle.

Specifically, in a state horizontal with the outer wall, as shown in FIG. 15(b), when the drone may control the propeller to rotate in a reverse direction to approach the outer wall through a translational motion, and when the drone reaches the outer wall, the drone may be fixed to the outer wall through the above-described method.

In this case, while the drone is approaching the outer wall through a translational motion, when the pitch posture angle becomes smaller than or larger than 90°, the drone may control a forward rotation and/or a reverse rotation of each of a plurality of propellers described with reference to FIG. 15(a) to control a pitch posture angle to be 90°.

Thereafter, when the drone is fixed to an outer wall, the drone may turn off a propeller and monitor a predetermined region or may charge the battery using a propeller rotating by the wind.

Alternatively, a monitoring operation and a charging operation may be simultaneously performed.

Thereafter, when charging is completed, the drone may fly again and complete a predetermined mission and when the mission is completed, the drone may return to a station or a control center.

In this way, when the drone lands on an outer wall using landing using an inertial force and a landing gear in contact with the outer wall, by landing on the outer wall in an emergency situation (battery shortage), automatic charging of the drone is available, and by performing a monitoring mission in a state attached to the outer wall, power consumed for hovering can be saved.

Apparatus in which the Present Invention May be Applied

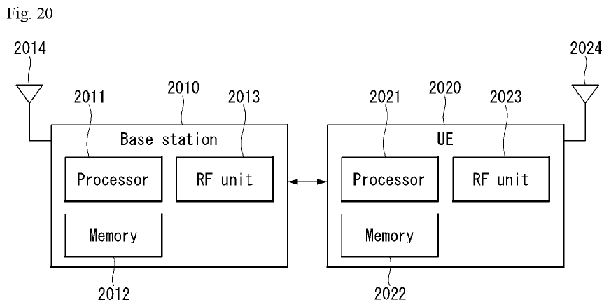

FIG. 20 is a block diagram illustrating a wireless communication device according to an embodiment of the present invention.

Referring to FIG. 20, a wireless communication system includes a base station (or network) 2010 and a terminal 2020.

Here, the terminal may be a UE, a UAV, a drone, and a wireless aerial robot.

The base station 2010 includes a processor 2011, a memory 2012, and a communication module 2013.

The processor implements a function, a process and/or a method suggested in FIGS. 1 to 19. Layers of a wired/wireless interface protocol may be implemented by the processor 2011. The memory 2012 is connected to the processor 2011 to store various information for driving the processor 2011. The communication module 2013 is connected to the processor 2011 to transmit and/or receive a wired/wireless signal.

The communication module 2013 may include a radio frequency (RF) unit for transmitting/receiving a wireless signal.

The terminal 2020 includes a processor 2021, a memory 2022, and a communication module (or RF unit) 2023. The processor 2021 implements a function, a process and/or a method suggested in FIGS. 1 to 19. Layers of a wireless interface protocol may be implemented by the processor 2021. The memory 2022 is connected to the processor 2021 to store various information for driving the processor 2021. The communication module 2023 is connected to the processor 2021 to transmit and/or receive a wireless signal.

The memories 2012 and 2022 may exist at the inside or the outside of the processors 2011 and 2021 and may be connected to the processors 2011 and 2021, respectively, by well-known various means.

Further, the base station 2010 and/or the terminal 2020 may have a single antenna or a multiple antenna.

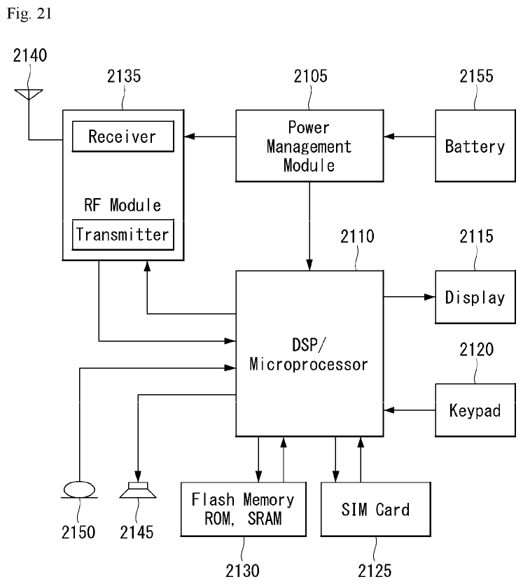

FIG. 21 is a block diagram illustrating a communication device according to an embodiment of the present invention.

In particular. FIG. 21 is a block diagram specifically illustrating the UE of FIG. 20. Referring to FIG. 21, the terminal may include a processor (or a digital signal processor (DSP)) 2110, an RF module (or RF unit) 2135, a power management module 2105, an antenna 2140, a battery 2155, a display 2115, a keypad 2120, a memory 2130, a subscriber identification module (SIM) card 2125 (this element is an option), a speaker 2145, and a microphone 2150. The terminal may include a single antenna or multiple antennas.

The processor 2110 implements a function, a process and/or a method suggested in FIGS. 1 to 19. A layer of a wireless interface protocol may be implemented by the processor 2110.

The memory 2130 is connected to the processor 2110 and stores information related to operation of the processor 2110. The memory 2130 may exist at the inside or the outside of the processor 2110 and may be connected to the processor 2110 by well-known various means.

The user inputs, for example, command information such as a phone number by pressing (touching) a button of the keypad 2120 or by voice activation using the microphone 2150. The processor 2110 processes to perform an appropriate function such as reception of such command information and calling with a phone number. Operational data may be extracted from the SIM card 2125 or the memory 2130. Further, for user recognition and convenience, the processor 2110 may display command information or driving information on the display 2115.

The RF module 2135 is connected to the processor 2110 to transmit and/or receive an RF signal. In order to start communication, for example, in order to transmit a wireless signal constituting voice communication data, the processor 2110 transfers command information to the RF module 2135. In order to receive and transmit a wireless signal, the RF module 2135 is configured with a receiver and a transmitter. The antenna 2140 performs a function of transmitting and receiving a wireless signal. When receiving a wireless signal, the RF module 2135 may transfer a signal in order to be processed by the processor 2110 and convert a signal with a base band. The processed signal may be converted to audible or readable information output through the speaker 2145.

In the foregoing embodiments, the elements and characteristics of the present invention have been combined in specific forms. Each of the elements or characteristics should be considered to be optional unless otherwise described explicitly. Each of the elements or characteristics may be implemented in a form that does not combine with other elements or characteristics. Further, some of the elements and/or the characteristics may be combined to constitute an embodiment of the present invention. The order of the operations described in the embodiments of the present invention may be changed. Some of the elements or characteristics of an embodiment may be included in another embodiment or may be replaced with corresponding elements or characteristics of another embodiment. It is evident that an embodiment may be constructed by combining claims having no explicit citation relation in the claims or may be included as a new claim by amendments after filing an application.

The embodiment of the present invention may be implemented by various means, for example, hardware, firmware, software or a combination of them. In the case of implementations by hardware, the embodiment of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers and microprocessors.

In the case of an implementation by firmware or software, the embodiment of the present invention may be implemented in the form of a module, procedure or function for performing the aforementioned functions or operations. A software code may be stored in the memory and driven by the processor. The memory may be located inside or outside the processor and may exchange data with the processor by various known means.

It is evident to those skilled in the art that the present invention may be materialized in other specific forms without departing from essential characteristics thereof. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

According to the present invention, while an unmanned aerial robot flies using 5G communication technology, when a battery amount is a predetermined amount or less, the unmanned aerial robot can land at a position perpendicular to the ground and generate power using the wind.

Further, in the present specification, as an unmanned aerial robot lands at a position perpendicular to the ground, the unmanned aerial robot can monitor a predetermined area without hovering in the air.

Further, in the present specification, by not performing hovering in order to monitor a predetermined region, power consumed in hovering can be reduced.

Further, in the present specification, by controlling a pitch posture angle of an unmanned aerial robot using a forward rotation and a reverse rotation of a propeller, the unmanned aerial robot can safely land at a position perpendicular to the ground.

The effects of the present invention are not limited to the above-described effects and the other effects will be understood by those skilled in the art from the description.

### INDUSTRIAL APPLICABILITY

Although a method of controlling an operation and posture of a drone of the present invention has been described with reference to a 3GPP LTE/LTE-A system and an example applied to 5G, the method can be applied to various wireless communication s stems.

What is claimed is:

1. A method of landing a rotary wing unmanned aerial robot, comprising:
recognizing a position for landing and perpendicular to the ground using a sensor;
moving to the recognized position;
controlling, when a distance between the position and the rotary wing unmanned aerial robot is within a predetermined distance, a posture of the rotary wing unmanned aerial robot and a pitch posture angle to the ground through a forward rotation and a reverse rotation of the propeller; and
landing at the position through the control of the posture and the pitch posture angle.

2. The method of claim 1, wherein the moving of to the recognized position is performed through a forward rotation of the propeller and comprises increasing a speed of a horizontal axis moving to the position.

3. The method of claim 1, wherein the controlling of a posture of the rotary wing unmanned aerial robot comprises:
increasing a vertical axis speed through the forward rotation; and
increasing the pitch posture angle through increase of the vertical axis speed.

4. The method of claim 3, wherein the controlling of a posture of the rotary wing unmanned aerial robot further comprises contacting the position using the forward rotation and the reverse rotation of the propeller, when the pitch posture angle is perpendicular to the ground, and
wherein the pitch posture angle is maintained through a forward rotation and/or a reverse rotation of each of the propellers.

5. The method of claim 4, wherein, when the pitch posture angle increases greater than a vertical angle, an upper propeller of the propellers performs a reverse rotation and a lower propeller thereof performs a forward rotation to vertically maintain the pitch posture angle.

6. The method of claim 4, wherein, when the pitch posture angle reduces smaller than a vertical angle, an upper propeller and a lower propeller of the propellers perform a forward rotation, and
wherein a rotation speed of the upper propeller is smaller than that of the lower propeller.

7. The method of claim 4, wherein, while the pitch posture angle maintains a vertical state, an upper propeller and a lower propeller of the propellers are moved to the position in the vertical state through a reverse rotation.

8. The method of claim 4, wherein, when the rotor unmanned aerial robot approaches to the position,
an upper propeller and a lower propeller of the propellers perform a reverse rotation, and
wherein a reverse rotation speed of the upper propeller is greater than that of the lower propeller.

9. The method of claim 4, wherein the controlling of a posture of the rotary wing unmanned aerial robot is performed in a state in which a vertical axis speed of the rotary wing unmanned aerial robot is 0.

10. The method of claim 1, further comprising:
generating, after the landing, power using a rotation of the propeller by the wind; and
charging a battery using the generated power.

11. The method of claim 1, further comprising monitoring, after the landing, a region within a predetermined range using a camera.

12. A rotary wing unmanned aerial robot, comprising:
a wireless communication unit;
a main body;
at least one motor;
at least one sensor;
a propeller connected to each of the at least one motor; and
a processor electrically connected to the at least one motor to control the at least one motor,
wherein the processor controls the at least one sensor to recognize a position for landing and perpendicular to the ground,
controls the at least one motor and the propeller to move to the recognized position,
controls the propeller and the at least one sensor to control a posture and a pitch posture angle to the ground of the rotary wing unmanned aerial robot through a forward rotation and a reverse rotation of the propeller when a distance between the position and the rotary wing unmanned aerial robot is within a predetermined distance, and
controls the propeller and the at least one sensor to land at the position through the control of the posture and the pitch posture angle.

13. The rotary wing unmanned aerial robot of claim 12, wherein the movement to the position is performed through a forward rotation of the propeller, and
wherein the processor increases a speed of a horizontal axis moving to the position.

14. The rotary wing unmanned aerial robot of claim 12, wherein the processor increases a speed of a vertical axis through the forward rotation and increases the pitch posture angle through the increased speed of the vertical axis.

15. The rotary wing unmanned aerial robot of claim 13, wherein the processor
contacts the rotary wing unmanned aerial robot at the position using the forward rotation and the reverse rotation of the propeller when the pitch posture angle is perpendicular to the ground, and
wherein the pitch posture angle is maintained through a forward rotation and/or a reverse rotation of each of the propellers.

16. The rotary wing unmanned aerial robot of claim 15, wherein, when the pitch posture angle increases greater than a vertical angle, an upper propeller of the propellers performs a reverse rotation, and a lower propeller performs a forward rotation to vertically maintain the pitch posture angle.

17. The rotary wing unmanned aerial robot of claim 15, wherein, when the pitch posture angle reduces smaller than a vertical angle, an upper propeller and a lower propeller of the propellers perform a forward rotation, and
wherein a rotation speed of the upper propeller is smaller than that of the lower propeller.

18. The rotary wing unmanned aerial robot of claim 15, wherein, while the pitch posture angle maintains a vertical angle, an upper propeller and a lower propeller of the propellers move to the position to the vertical state through a reverse rotation.

19. The rotary wing unmanned aerial robot of claim 15, wherein, when the rotor unmanned aerial robot approaches to the position, an upper propeller and a lower propeller of the propellers perform a reverse rotation, and
wherein a reverse rotation speed of the upper propeller is greater than that of the lower propeller.

20. The rotary wing unmanned aerial robot of claim 15, wherein the control of a posture and a pitch posture angle is performed in a state in which a vertical axis speed of the rotary wing unmanned aerial robot is 0.
